(19) United States
(12) Patent Application Publication
(10) Pub. No.: US 2026/0040145 A1
(43) Pub. Date: Feb. 5, 2026

(54) DYNAMIC SCALING OF VIRTUAL CONTAINERS IN A CONTAINERIZED ENVIRONMENT

(71) Applicant: DISH Wireless L.L.C., Englewood, CO (US)

(72) Inventors: Gurpreet Sohi, Parker, CO (US); Julio Roberto Armenta, Aldie, VA (US); Ahmed Mostafa GINAH, Centennial, CO (US)

(21) Appl. No.: 18/791,320

(22) Filed: Jul. 31, 2024

(51) Int. Cl. H04W 28/16; G06F 9/50

(52) U.S. Cl. CPC H04W 28/16; G06F 9/5077

(57) ABSTRACT

An apparatus comprises a memory and a processor communicatively coupled to one another. The processor is configured to determine network resource availability information in a communication network and execute a machine learning algorithm to analyze the network resource availability information based at least in part upon one or more communication conditions, generate one or more analysis results in response to analyzing the network resource availability information; and generate one or more network assignment recommendations based at least in part upon the plurality of analysis results and historical data. Further, the processor is configured to assign a second plurality of resources in the containerized environment over the second time period and rescale one or more virtual containers in the containerized environment to use the second plurality of resources.

### TECHNICAL FIELD

The present disclosure relates generally to scaling operations performed in a containerized environment, and more specifically to a system and method configured to dynamically scale virtual containers in the containerized environment.

### BACKGROUND

Communication systems comprise a finite number of resources available to perform daily communication operations. The output demands of the communication systems may increase as traffic is increased in specific areas of a communication network. As the output demands of the communication systems increase, these systems may be configured to power down to allow for additional resources to be allocated to perform additional communication operations. In cases where the communication systems are powered down or offline, communication operations are disrupted and exchanges of data may not be completed in the communication network.

### SUMMARY OF THE DISCLOSURE

In one or more embodiments, systems and methods disclosed herein are configured to dynamically scale and/or rescale virtual containers in one or more containerized environments. The virtual containers may be one or more deployable units of a system comprising one or more processing resource and one or more memory resources. The virtual containers are configured to share some or all the processing resources and the memory resources among each other. Each of the virtual containers may be configured in accordance with one or more access commands to aid in performing one or more communication operations in a communication network. In some embodiments, the virtual containers may be deployed in one or more containerized environments. In some embodiments, the systems are configured to modify the virtual containers in one or more containerized environments dynamically based on current demands of the communication network. The systems may be configured to scale and/or rescale the virtual containers to match the demands in real-time. Herein, real-time may refer to near instant (e.g., within one or more seconds or less) operations performed in short proximity to one another. The systems may be configured to preemptively scale and/or rescale the virtual containers in accordance with expected demands over a specific time duration. In other embodiments, the systems may be configured to execute one or more machine learning (ML) algorithms and one or more artificial intelligence (AI) commands trained in accordance with one or more ML models to monitor, structure, and evaluate network resource availability information in the communication network over time.

In one or more embodiments, the systems are configured to dynamically scale (and/or rescale) the virtual containers vertically and/or horizontally. The virtual containers may be scaled out horizontally by adding new virtual containers in a given containerized environment. The virtual containers may be scaled in horizontally by removing existing virtual containers in a given containerized environment. The virtual containers may be scaled up vertically by adding new processing resources and/or memory resources in one or more virtual containers in a given containerized environment. The virtual containers may be scaled down vertically by removing existing processing resources and/or memory resources in one or more virtual containers in a given containerized environment. In one or more embodiments, the systems may be configured to dynamically scale the virtual containers vertically and horizontally at a same time, simultaneously, in conjunction with one another, and/or within a period of time.

In one or more embodiments, the systems and methods described herein are integrated into a practical application to dynamically scale (and/or rescale) virtual containers in a containerized environment. In particular, the systems and methods are integrated into practical applications of: (1) monitoring consumption of network resources at each virtual container at each containerized environment at any point in time; (2) regulating, modifying, and/or controlling consumption of network resources at each virtual container in a containerized environment comprising multiple virtual containers; (3) dynamically redistribute network resources among virtual containers in one or more containerized environments; and (4) regulating, modifying, and/or controlling usage of network resources in the communication network. The systems and methods may be configured to provide a deep understanding of network resources consumed at any containerized environments within a communication site. At a given point in time, the systems and methods may be configured to trigger replacement of any number of specific virtual containers if network resource consumption at a given virtual container is determined to be outside a threshold. The threshold may be a dynamically updated threshold and/or a predefined threshold.

In addition, the systems and methods described herein are integrated into a technical advantage of increasing processing speeds in a computer system, because processors associated with the systems are configured to dynamically control consumption of network resources in a containerized environment. In some embodiments, the systems and methods are configured to increase allocation efficiency of processing resources and memory resources at the containerized environments by actively determining network resource consumption in specific virtual containers and modifying system configuration to change a number of virtual containers and/or corresponding allocated resources throughout a communication network. Further, the systems and methods are integrated into a technical advantage of improving usage of existing containerized environments in the communication network comprising multiple virtual containers by simultaneously controlling consumption of network resources at one or more virtual containers. In this regard, the systems and methods are configured to perform one or more scaling operations that inhibit, prevent, and/or reduce reliance on existing container configurations by dynamically reassigning network resources in virtual containers configured to perform specific communication operations in the communication network. Herein, the systems may be configured to increase the efficiency of network resources in the communication network.

In one or more embodiments, the systems and methods may be performed by an apparatus, such as a server (e.g., comprising the non-real time RIC), communicatively coupled to multiple network components in a core network, one or more base stations in a radio access network, and one or more user equipment. Further, the systems may be a wireless communication system, which comprises the apparatus. In addition, the systems may be performed as part of a process performed by the apparatus communicatively coupled to the network components in the core network. As a non-limiting example, the apparatus may comprise a memory and a processor communicatively coupled to one another. The memory may be operable to store a machine learning algorithm configured, when executed, to analyze and structure information about resources assigned in a containerized environment and historical data representative of one or more network resources assigned in the containerized environment over a first time period. The processor may be configured to determine network resource availability information in a communication network. The network resource availability information may indicate network resources available for assignment in the containerized environment over a second time period. Further, the processor may be configured to execute the machine learning algorithm to analyze the network resource availability information based at least in part upon one or more communication conditions, generate one or more analysis results in response to analyzing the network resource availability information; and generate one or more network assignment recommendations based at least in part upon the plurality of analysis results and the historical data. The processor may be configured to assign a second plurality of resources in the containerized environment over the second time period and rescale one or more virtual containers in the containerized environment to use the second plurality of resources.

Certain embodiments of this disclosure may comprise some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example communication system, in accordance with one or more embodiments;

FIGS. 2A-2D illustrate a first example virtual container scaling cycle, in accordance with one or more embodiments;

FIGS. 3A-3D illustrate a second example virtual container scaling cycle, in accordance with one or more embodiments;

FIGS. 4A and 4B illustrate a third example virtual container scaling cycle, in accordance with one or more embodiments; and

FIG. 5 illustrates an example flowchart of a method to perform one or more scaling operations, in accordance with one or more embodiments.

### EXAMPLE EMBODIMENTS

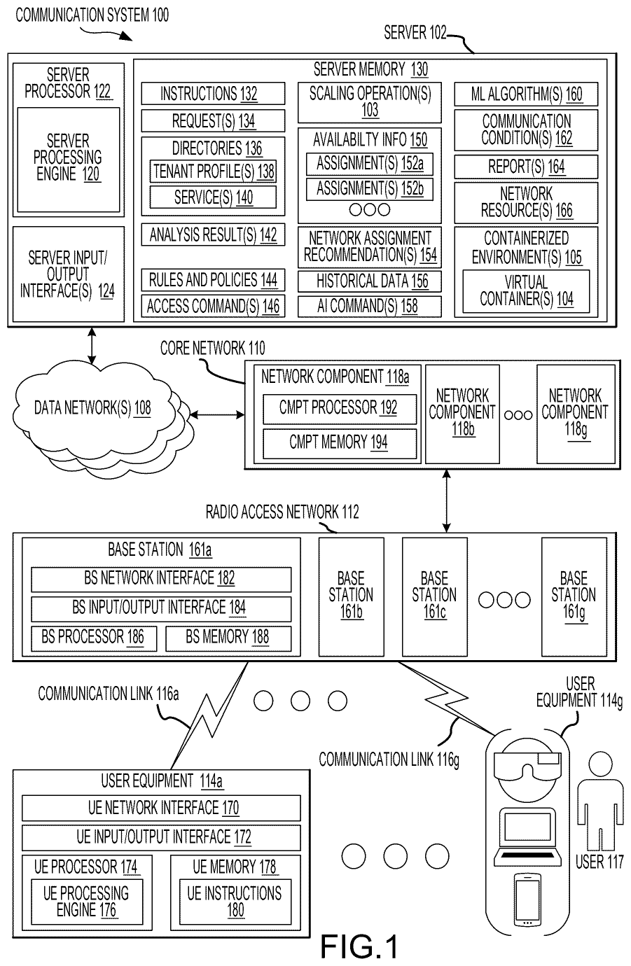

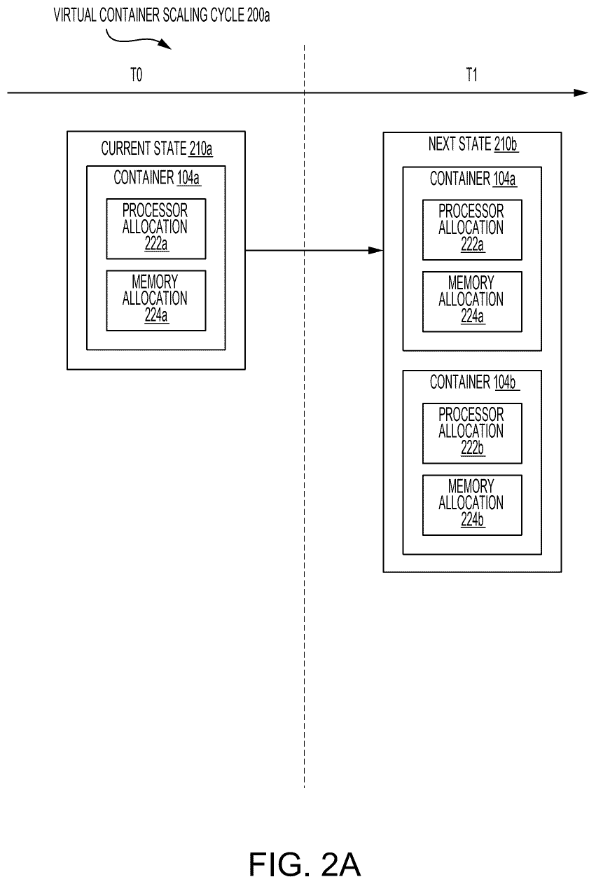

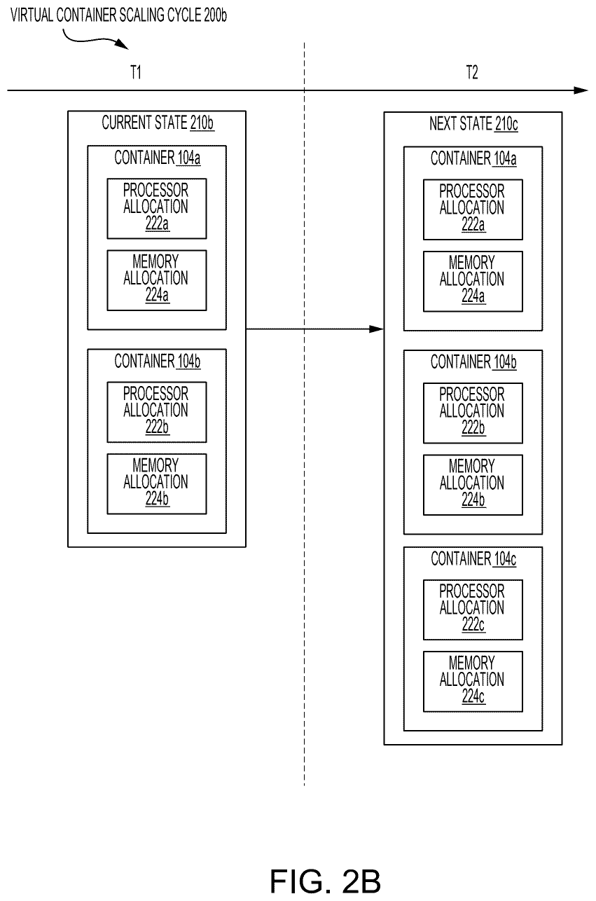

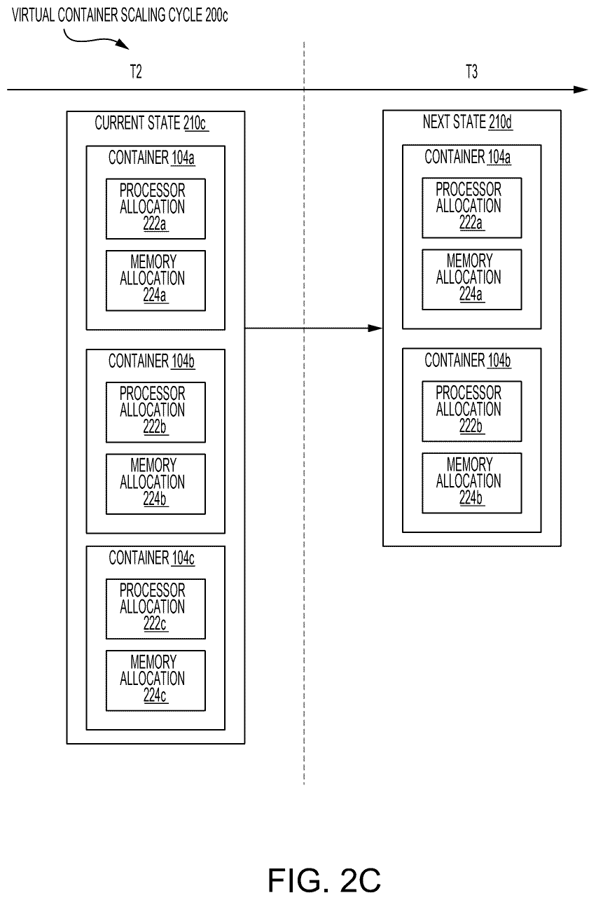

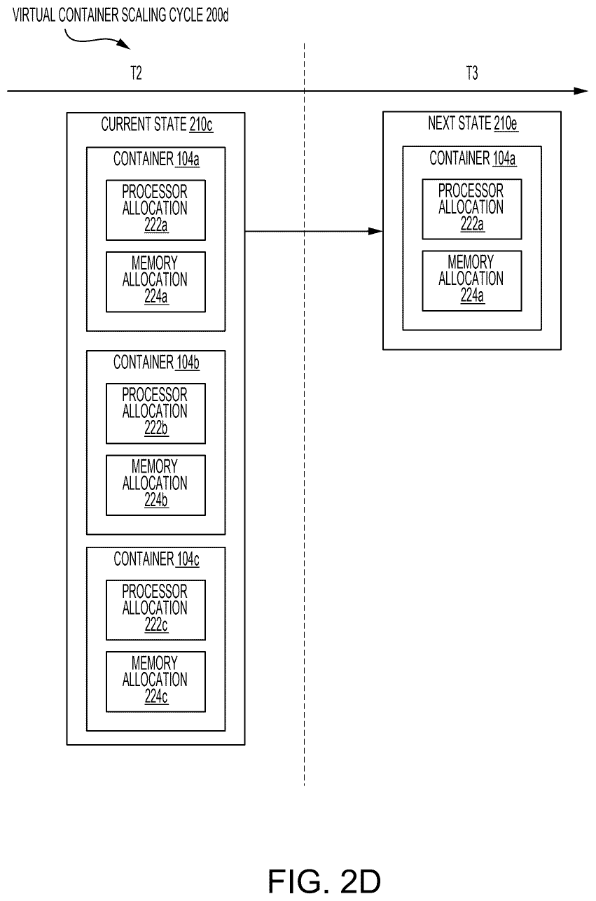

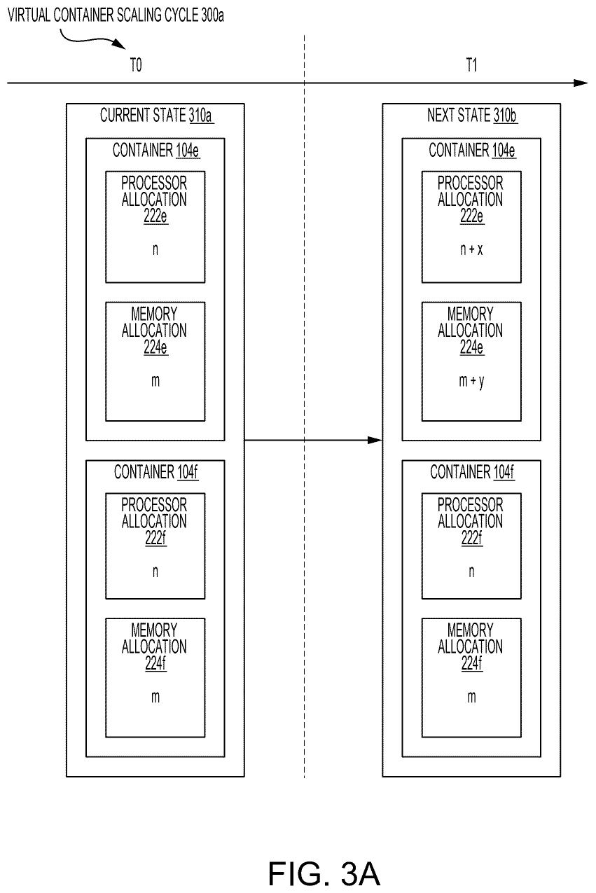

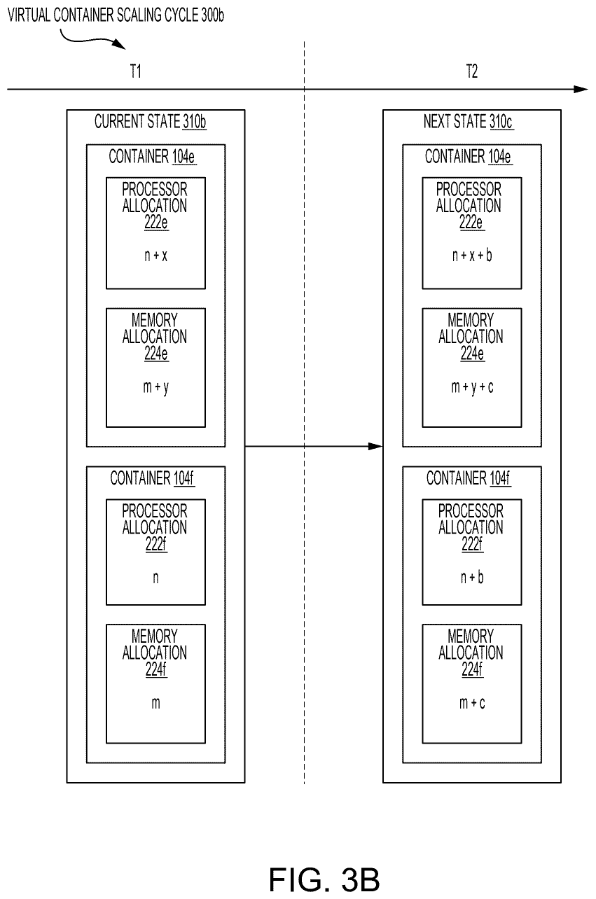

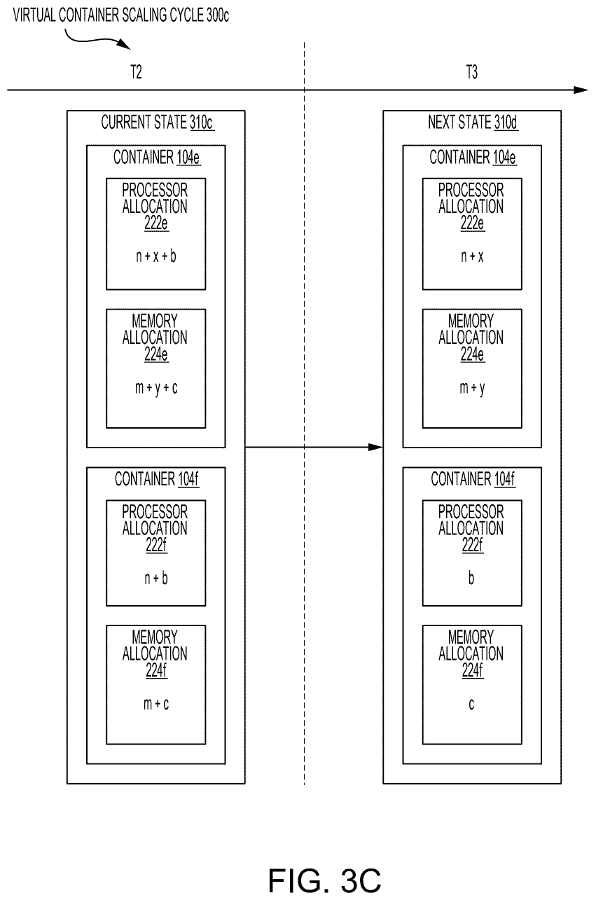

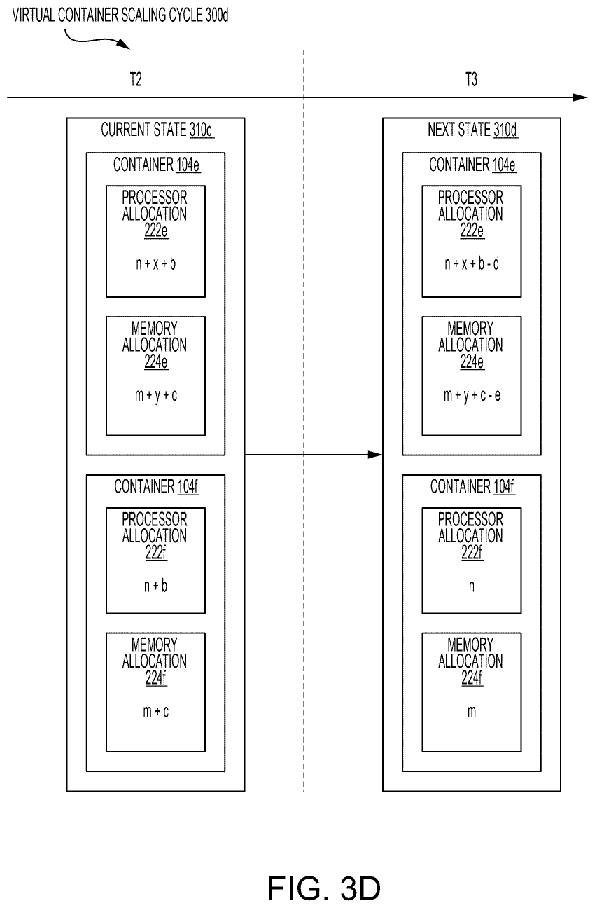

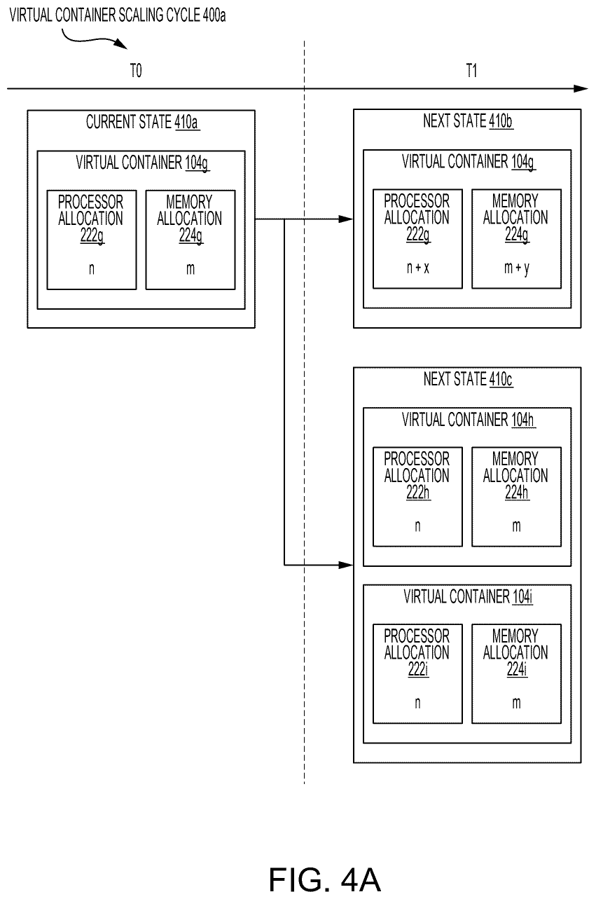

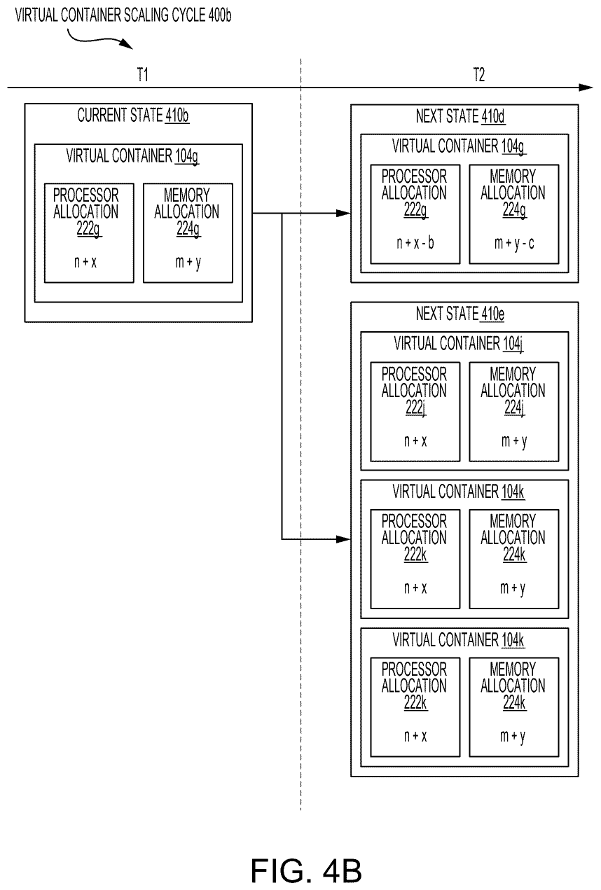

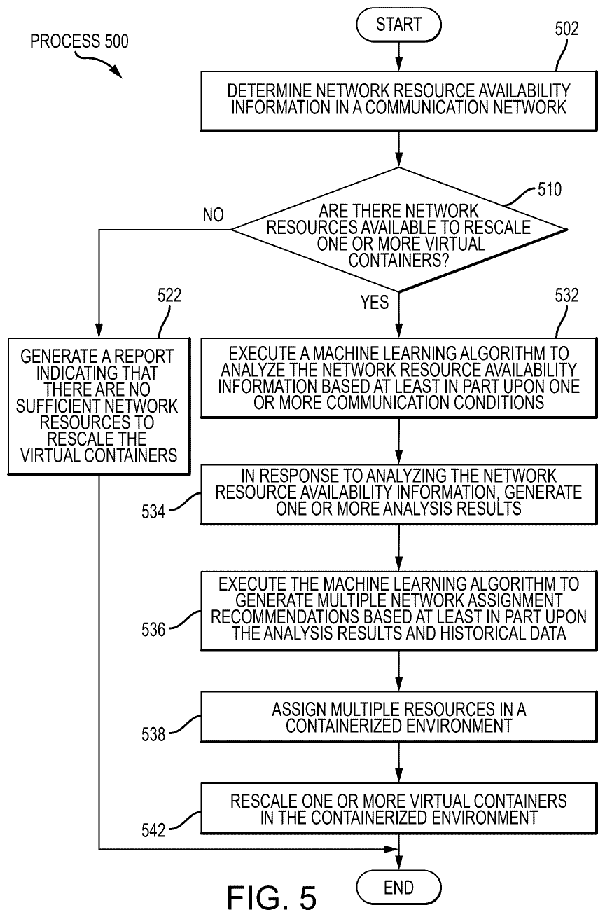

In one or more embodiments, systems and methods described herein are configured to perform one or more scaling operations. In one or more embodiments, FIG. 1 illustrates a communication system 100 in which a server 102 is configured to perform one or more scaling operations 103. FIGS. 2A-2D illustrate virtual container scaling cycles 200A-200D in which the communication system 100 of FIG. 1 is configured to perform the one or more scaling operations 103. FIGS. 3A-3D illustrate virtual container scaling cycles 300A-300D in which the communication system 100 of FIG. 1 is configured to perform the one or more scaling operations 103. FIGS. 4A and 4B illustrate virtual container scaling cycles 400A-400C in which the communication system 100 of FIG. 1 is configured to perform the one or more scaling operations 103. FIG. 5 illustrates a process 500 to dynamically scale virtual containers 104 in at least one containerized environment 105.

### Communication System Overview

FIG. 1 illustrates a diagram of a communication system 100 (e.g., a wireless communication system) that comprises a server 102 configured to perform one or more scaling operations 103, in accordance with one or more embodiments. In the communication system 100 of FIG. 1, the server 102 may be the communication terminal communicatively coupled to one or more data networks 108, a core network 110, and a radio access network (RAN) 112. In FIG. 1, the server 102 is communicatively coupled to multiple user equipment 114a-114g (collectively, user equipment 114) via the RAN 112 via multiple corresponding communication links 116a-116g (collectively, communication links 116) established between each user equipment 114 and the RAN 112. As represented by a user equipment 114a, the user equipment 114 may be operated or attended by one or more users 117. In the example of FIG. 1, the server 102 may be communicatively coupled to multiple additional devices in the communication system 100. While FIG. 1 shows the server 102 connected directly to the one or more data networks 108, the server 102 may be located inside the core network 110 as part of one or more of the network components (e.g., any of the network components 118a-118g) in the core network 110.

In one or more embodiments, the communication system 100 comprises the user equipment 114, the RAN 112, the core network 110, the one or more data networks 108, and the server 102. In come embodiments, the communication system 100 may comprise a Fifth Generation (5G) mobile network or wireless communication system, utilizing high frequency bands (e.g., 24 Gigahertz (GHz), 39 GHz, and the like) or lower frequency bands such (e.g., Sub 6 GHZ). In this regard, the communication system 100 may comprise a large number of antennas. In some embodiments, the communication system may perform one or more operations associated with the 5G New Radio (NR) protocols described in reference to the Third Generation Partnership Project (3GPP). As part of the 5G NR protocols, the communication system 100 may perform one or more millimeter (mm) wave technology operations to improve bandwidth or latency in wireless communications.

In some embodiments, the communication system 100 may be configured to partially or completely enable communications via one or more various radio access technologies (RATs), wireless communication technologies, or telecommunication standards, such as Global System for Mobiles (GSM) (e.g., Second Generation (2G) mobile networks), Universal Mobile Telecommunications System (UMTS) (e.g., Third Generation (3G) mobile networks), Long Term Evolution (LTE) of mobile networks, LTE-Advanced (LTE-A) mobile networks, 5G NR mobile networks, or Sixth Generation (6G) mobile networks.

### Communication System Components

### Server

The server 102 is generally any device or apparatus that is configured to process data, communicate with the data networks 108, one or more network components 118a-118g (collectively, network components 118) in the core network 110, the RAN 112, and the user equipment 114. The server 102 may be configured to monitor, track data, control routing of signal, and control operations of certain electronic components in the communication system 100, associated databases, associated systems, and the like, via one or more interfaces. The server 102 is generally configured to oversee operations of a server processing engine 120. The operations of the server processing engine 120 are described further below. In some embodiments, the server 102 comprises a server processor 122, one or more server Input (I)/Output (O) interfaces 124, and a server memory 130 communicatively coupled to one another. The server 102 may be configured as shown, or in any other configuration. As described above, the server 102 may be located in one of the network components 118 located in the core network 110 and may be configured to perform one or more network functions (NFs).

The server processor 122 may comprise one or more processors operably coupled to and in signal communication with the one or more server I/O interfaces 124, and the server memory 130. The server processor 122 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The server processor 122 may be a programmable logic device, a microcontroller, a microprocessor, or any suitable combination of the preceding. The one or more processors in the server processor 122 are configured to process data and may be implemented in hardware or software executed by hardware. For example, the server processor 122 may be an 8-bit, a 16-bit, a 32-bit, a 64-bit, or any other suitable architecture. The server processor 122 may comprise an arithmetic logic unit (ALU) to perform arithmetic and logic operations, processor registers that supply operands to the ALU, and store the results of ALU operations, and a control unit that fetches software instructions such as server instructions 132 from the server memory 130 and executes the server instructions 132 by directing the coordinated operations of the ALU, registers and other components via the server processing engine 120. The server processor 122 may be configured to execute various instructions. For example, the server processor 122 may be configured to execute the server instructions 132 to perform functions or perform operations disclosed herein, such as some or all of those described with respect to FIGS. 1-5. In some embodiments, the functions described herein are implemented using logic units, FPGAs, ASICs, DSPs, or any other suitable hardware or electronic circuitry.

In one or more embodiments, the server I/O interfaces 124 may be hardware configured to perform one or more communication operations described in reference to FIG. 5. The server I/O interfaces 124 may comprise one or more antennas as part of a transceiver, a receiver, or a transmitter for communicating using one or more wireless communication protocols or technologies. In some embodiments, the server I/O interfaces 124 may be configured to communicate using, for example, NR or LTE using at least some shared radio components. In other embodiments, the server I/O interfaces 124 may be configured to communicate using single or shared radio frequency (RF) bands. The RF bands may be coupled to a single antenna, or may be coupled to multiple antennas (e.g., for a multiple-input multiple output (MIMO) configuration) to perform wireless communications. The server I/O interfaces 124 may be configured to comprise one or more peripherals such as a network interface, one or more administrator interfaces, and one or more displays.

The server network interfaces that may be part of the server I/O interfaces 124 may be any suitable hardware or software (e.g., executed by hardware) to facilitate any suitable type of communication in wireless or wired connections. These connections may comprise, but not be limited to, all or a portion of network connections coupled to additional network components 118 in the core network 110, the RAN 112, the user equipment 114, the Internet, an Intranet, a private network, a public network, a peer-to-peer network, the public switched telephone network, a cellular network, a local area network (LAN), a metropolitan area network (MAN), a wide area network (WAN), and a satellite network. The server network interface may be configured to support any suitable type of communication protocol.

The one or more administrator interfaces that may be part of the server I/O interfaces 124 may be user interfaces configured to provide access and control to of the server 102 to one or more users (e.g., the user 117) or electronic devices. The one or more users may access the server memory 130 upon confirming one or more access credentials to demonstrate that access or control to the server 102 may be modified. In some embodiments, the one or more administrator interfaces may be configured to provide hardware and software resources to the one or more users. Examples of user devices comprise, but are not limited to, a laptop, a computer, a smartphone, a tablet, a smart device, an Internet-of-Things (IoT) device, a simulated reality device, an augmented reality device, or any other suitable type of device. The administrator interfaces may enable access to one or more graphical user interfaces (GUIs) via an image generator display (e.g., one or more displays), a touchscreen, a touchpad, multiple keys, multiple buttons, a mouse, or any other suitable type of hardware that allow users to view data or to provide inputs into the server 102. The server 102 may be configured to allow users to send requests to one or more user equipment 114.

In the example of FIG. 1, the one or more displays that may be part of the server I/O interfaces 124 may be configured to display a two-dimensional (2D) or three-dimensional (3D) representation of a service. Examples of the representations may comprise, but are not limited to, a graphical or simulated representation of an application, diagram, tables, or any other suitable type of data information or representation. In some embodiments, the one or more displays may be configured to present visual information to one or more users (not shown). The one or more displays may be configured to present visual information to the one or more users updated in real-time. The one or more displays may be a wearable optical display (e.g., glasses or a head-mounted display (HMD)) configured to reflect projected images and enable user to see through the one or more displays. For example, the one or more displays may comprise display units, one or more lenses, one or more semi-transparent mirrors embedded in an eye glass structure, a visor structure, or a helmet structure. Examples of display units comprise, but are not limited to, a cathode ray tube (CRT) display, a liquid crystal display (LCD), a liquid crystal on silicon (LCOS) display, a light emitting diode (LED) display, an organic LED (OLED) display, an active-matrix OLED (AMOLED) display, a projector display, or any other suitable type of display. In another embodiment, the one or more displays are a graphical display on the server 102. For example, the graphical display may be a tablet display or a smartphone display configured to display the data representations.

The server memory 130 may be volatile or non-volatile and may comprise a read-only memory (ROM), random-access memory (RAM), ternary content-addressable memory (TCAM), dynamic random-access memory (DRAM), and static random-access memory (SRAM). The server memory 130 may be implemented using one or more disks, tape drives, solid-state drives, and/or the like. The server memory 130 is operable to store the server instructions 132, one or more requests 134, one or more directories 136 comprising one or more tenant profiles 138 associated with one or more services 140, one or more analysis results 142, one or more rules and policies 144, one or more access commands 146, the one or more scaling operations 103, network resource availability information 150 comprising one or more assignments 152 (e.g., an assignment 152a and an assignment 152b among others), one or more network assignment recommendations 154, historical data 156, multiple artificial intelligence commands 158, a machine learning algorithm 160, one or more communication conditions 162, one or more reports 164, one or more network resources 166, and the one or more containerized environments 105 comprising one or more virtual containers 104. In the server memory 130, the server instructions 132 may comprise commands and controls for operating one or more specific NFs in the core network 110 when executed by the server processing engine 120 of the server processor 122.

In one or more embodiments, the instructions 132 are configured to instruct one or more network components 118 in the core network 110 to establish one or more configuration scripts to perform one or more scaling operations 103 and/or additional operations. The one or more configuration scripts may be configured to enable automation of routing and/or configuration of network components 118 in the core network 110. In this regard, the one or more configuration scripts may reconfigure multiple cloud-NFs (CNFs) that establish initial communication sessions with at least one network repository function (NRF) in a communication path comprising one or more additional network components 118. In this regard, the one or more configuration scripts may be configured to instruct routing and/or configuration of communication procedures based on static routing commands to restore services (e.g., applications) in the core network 110.

The one or more requests 134 may be a communication or a message configured to indicate a request for access of an application (via an API) or a service 140. The requests 134 may be communications and/or messages requesting access to specific network resources in a network slice in accordance with a corresponding priority level. Further, the requests 134 may be configured to provide one or more connectivity requests (e.g., access) between the server 102, the user equipment 114, one or more base stations 161, and one or more of the network components 118.

The one or more directories 136 may be configured to store service-specific information and/or user-specific information. The directories 136 may enable the server 102 to confirm user credentials to access one or more network components (e.g., one of the network components 118 configured to perform one or more NFs in the core network 110). The directories 136 may be configured to store provider-specific information. The directories 136 may enable the server 102 to validate credentials associated with a specific provider (e.g., one of the CNFs) against corresponding user-specific information in the directories 136. The directories 136 may be configured to store the tenant profiles 138 and a reference to the one or more services 140. The directories 136 may be configured to store provider-specific information and service-specific information. The provider-specific information may enable the server 102 to validate credentials associated with a specific provider (e.g., one of the NFs) against corresponding user-specific information and service-specific information.

The one or more analysis results 142 may be one or more results of one or more analyses performed by the server processor 122. The analyses may be performed as part of one or more operations triggered after executing the one or more instructions 132 (e.g., comprising executing the ML algorithm 160). The analysis results 142 may be structured data comprising information in the form of lists, tables, and/or databases among others.

In one or more embodiments, the one or more rules and policies 144 are configured to instruct the one or more user equipment 114 to establish one or more access commands 146 to perform one or more operations in the communication system 100 in a specific order. The one or more rules and policies 144 may enable automation of the analysis of the requests 134, the network assignment recommendations 154, and/or the one or more scaling operations 103. Further, the rules and policies 144 may indicate one or more changes to the scaling operations 103. In some embodiments, the one or more rules and policies 144 may be predetermined and/or dynamically assigned by a corresponding user 117 or an organization associated with the server 102.

In one or more embodiments, the access commands 146 are configured to establish one or more communication sessions between the network components 118 in the core network 110 and the user equipment 114. Each configuration command of the access commands 146 may be configured to provide control information to perform one or more of the operations. Further, the access commands 146 may be routing and configuration information for reinstating or reestablishing communication sessions. The access commands 146 may one or more power consumption guidelines. The access commands 146 may be dynamically or periodically updated from the network components 118 in the core network 110.

In one or more embodiments, the scaling operations 103 are one or more operations performed to inhibit, reduce, and/or prevent loss and/or waste of network resources 166. Further, the scaling operations 103 are one or more operations regulate and/or control processing consumption, memory consumption, and/or power consumption. The scaling operations 103 may be configured to provide control information to perform one or more operations based at least in part upon analyzed data from one or more communication operations. The scaling operations 103 may be routing and configuration information for establishing, reinstating, and/or reestablishing communication sessions between the server 102 and one or more network components 118, one or more base stations 161, and/or one or more user equipment 114. The scaling operations 103 may be dynamically or periodically updated based on one or more rules and policies 144. In one or more embodiments, the access commands 146 are configured to establish one or more communication sessions between two or more network components 118 in the core network 110. The access commands 146 may be configured to establish one or more communication sessions between one or more network components 118 in the core network 110 and one of the user equipment 114. Each configuration command of the access commands 146 may establish a communication session between a first network component of the network components 118 comprising the server 102 and a second network component of the network components 118 based at least in part upon a first configuration command of the access commands 146. The access commands 146 may be routing and configuration information for reinstating or reestablishing communication sessions when a change is detected in the operations of the core network 110. For example, in response to losing a specific communication session established with the first access command, the server 102 may attempt to reinstate the specific communication session based at least in part upon a second access command. The access commands 146 may be dynamically or periodically updated from another of the network components 118 in the core network 110. Herein, communication sessions refer to communication signals exchanged between the server 102 and additional network components 118 in the core network 110. In some embodiments, the access commands 146 are provided to the server 102 from another of the network components 118 performing a specific NF. The access commands 146 may be configured to enable access of the one or more services 140. The access commands 146 may be configured to enable access of one or more name-spaces (not shown) and/or one or more slice groups (not shown) in a given containerized cluster.

In one or more embodiments, the one or more scaling operations 103 may be configured to dynamically scale and/or rescale virtual containers in one or more containerized environments 105. The virtual containers 104 may be one or more deployable units of a system comprising one or more processing resource, one or more memory resources, and/or one or more power resources. The virtual containers 104 are configured to share some or all the processing resources and the memory resources among each other. Each of the virtual containers 104 may be configured in accordance with one or more access commands 146 to aid in performing one or more communication operations in a communication network. In some embodiments, the virtual containers 104 may be deployed in one or more containerized environments 105. In some embodiments, the one or more scaling operations 103 are configured to modify the virtual containers 104 in one or more containerized environments 105 dynamically based on current demands of the communication network. The one or more scaling operations 103 may be configured to scale and/or rescale the virtual containers 104 to match the demands in real-time. Herein, real-time may refer to near instant (e.g., within one or more seconds or less) operations performed in short proximity to one another. The one or more scaling operations 103 may be configured to preemptively scale and/or rescale the virtual containers 104 in accordance with expected demands over a specific time duration. In other embodiments, the one or more scaling operations 103 may be configured to execute the one or more machine learning algorithms 160 and one or more artificial intelligence commands 158 trained in accordance with one or more machine learning models to monitor, structure, and evaluate network resource availability information in the communication network over time.

In one or more embodiments, the one or more scaling operations 103 are configured to dynamically scale (and/or rescale) the virtual containers 104 vertically and/or horizontally. The virtual containers 104 may be scaled out horizontally by adding new virtual containers 104 in a given containerized environment 105. The virtual containers 104 may be scaled in horizontally by removing existing virtual containers 104 in a given containerized environment 105. The virtual containers 104 may be scaled up vertically by adding new processing resources and/or memory resources in one or more virtual containers 104 in a given containerized environment 105. The virtual containers 104 may be scaled down vertically by removing existing processing resources and/or memory resources in one or more virtual containers 104 in a given containerized environment 105. In one or more embodiments, the systems may be configured to dynamically scale the virtual containers 104 vertically and horizontally at a same time, simultaneously, in conjunction with one another, and/or within a period of time.

In some embodiments, the network resource availability information 150 may be information comprising availability of the network resources 166 currently communicatively coupled to the server 102. In some embodiments, the network resource availability information 150 is predefined information received by the server 102 during a maintenance window. In other embodiments, the network resource availability information 150 is dynamically modified information that is received by the server 102 outside of a maintenance window. In one or more embodiments, the server 102 may receive and/or update the network resource availability information 150 statically (e.g., predefined) and/or dynamically over time. In some embodiments, the network resource availability information 150 may be updated in accordance with rules and policies 144 of an organization. The network resource availability information 150 may comprise allocation information and/or commands to modify usage of the network resources 166. The network resource availability information 150 may comprise one or more assignments 152 (e.g., shown as representative one or more assignments 152a and one or more assignments 152b) corresponding to one or more corresponding virtual containers 104 and/or one or more containerized environments 105. The assignments 152 may be configured to distribute or redistribute the network resources 166 to modify operations at one or more communication sites (e.g., locations and/or areas comprising the base stations 161 in the RAN 112). The assignments 152 may comprise modifications (e.g., increase, reduction, and/or replacement) of the network resources 166 distributed to one or more of the communication sites, the virtual containers 104, and/or the containerized environments 105.

The network resources 166 may comprise power resources associated with a power supply, processing resources associated with a processor, and/or memory resources associated with a memory. In one or more embodiments, the network resources 166 may be dynamically enabled at any given virtual container 104 to modify routing operations of communication sessions. The network resources 166 may be modified at the given virtual containers 104 and/or containerized environments 105 to prioritize assigning resources to maintain certain communication sessions. For example, one or more processing resources may be reassigned at virtual container 104 from one communication session to another communication session. In some embodiments, the assignments 152 may be modified in response to detecting a change or modification caused for a specific type of resource. For example, the network resources 166 may be reassigned to prioritize communication sessions between emergency organizations in a predefined area. In this example, a first number of the network resources 166 assigned to a first communication session may be dynamically reduced by an amount while a second number of the network resources 166 may be dynamically increased by the same amount. The assignments 152 may be generated dynamically (e.g., on demand) or periodically.

In one or more embodiments, the assignments 152 cause additional virtual containers 104 to be generated and/or previous virtual containers 104 to be discarded and/or deactivated. The assignments 152 may cause different resource pools providing one or more specific network resources 166 to the virtual containers 104 to be modified. For example, the network resources 166 assigned for virtual containers 104 in a college campus may be dynamically modified based on student attendance, campus events, weather changes, and the like. Further, the network resources 166 may be dynamically assigned, redistributed, and/or modified for different slices overlapping the resource pools. In the containerized environments 105, the virtual containers 104 may be assigned to specific cores and/or specific containerized clusters. In one or more embodiments, the virtual containers 104a-1040 are allocated in different order and/or different cores than those shown in FIGS. 2A-4B.

The server 102 may be configured to distribute, redistribute, assign, and/or reassign the network resources 166 corresponding to multiple cells into the multiple virtual containers 104. In some embodiments, the server 102 may be configured to analyze the network resources 166 available for different cells associated with the communication system 100 and assign these network resources 166 to individual virtual containers 104 of equal or different size. The virtual containers 104 may be configured to be deployed in one or more containerized environments 105 (e.g., Kubernetes environment). The virtual containers 104 may comprise network resources 166 that are co-located and co-scheduled. The virtual containers 104 may be pods configured as redundancies of one another or as standalone portions of the communication network. Herein, the server 102 may be configured to dynamically assign the network resources 166 during maintenance windows. Further, the server 102 may be configured to dynamically assign the network resources 166 outside of maintenance windows.

The network assignment recommendations 154 may be recommendations presented to the server 102 comprising suggestions to modify a number of network resources 166 assigned to perform and/or facilitate communication operations at the network components 118, the base stations 161, and/or the user equipment 114 based on the network resource availability information 150 and the one or more communication conditions 162. The network assignment recommendations 154 may comprise one or more dynamic suggestions to modify the one or more access commands 146. In one or more embodiments, the dynamic suggestions are the one or more scaling operations 103 configured to control and/or modify operations of the server 102. The scaling operations 103 may be configured to dynamically provide control information to perform one or more of the operations based at least in part upon the analyzed network resource availability information 150 and the one or more communication conditions 162. In one or more embodiments, the network assignment recommendations 154 may be configuration elements configured to associate a portion of the communication spectrum with one or more service releases. The network assignment recommendations 154 may be data and/or commands derived from the analysis results 142. In this regard, the analysis results 142 may be further evaluated to generate the network assignment recommendations 154. The network assignment recommendations 154 may be configured to provide one or more suggestions to modify (e.g., add, maintain, and/or remove) entire virtual containers 104 comprising the network resources 166 in a given communication site. The network assignment recommendations 154 may be suggestions configured to be performed immediately (e.g., within a short period of time, such as a couple of seconds or less), over a period of time (e.g., periodically over a period of time), and/or at a scheduled time (e.g., at a later time). The network assignment recommendations 154 may suggest implementation of one or more assignments 152 in the communication sites. The assignments 152 may be deployed simultaneously and/or in sequence. The assignments 152 suggested and/or provided by the network assignment recommendations 154 may be configured as redundancies of one another or as standalone assignments in a wireless communication network. For example, two or more virtual containers 104 may be configured to perform one or more similar operations. The network assignment recommendations 154 may be recommendations presented to modify allocation of the network resources 166 used by the network components 118, the base stations 161, and/or the user equipment 114 based on the analysis results 142. The network assignment recommendations 154 may comprise one or more dynamic suggestions to modify the access commands 146. In one or more embodiments, the dynamic suggestions are the one or more access commands 146 configured to control operations of the server 102, the network components 118, the base stations 161, and/or the user equipment 114. The assignments 152 may be optimized access commands configured to dynamically provide control information to perform one or more of the operations based at least in part upon the analysis results 142 and/or the historical data 156.

The historical data 156 may be historic information associated with one or more communication sites in a communication network comprising several communication sites. The historical data 156 may comprise one or more historic indicators representing one or more trends associated with power consumption for a specific communication site, a group of communication sites, and/or several communication sites in the communication network.

In one or more embodiments, the machine learning algorithm 160 may be executed by the server processor 122 to evaluate the usage in the network resources 166 in the virtual containers 104. Further, the machine learning algorithm 160 may be configured to interpret and transform information associated with the requests 134 and the historical data 156 into structured data sets and subsequently stored as files or tables. The machine learning algorithm 160 may cleanse, normalize raw data, and derive intermediate data to generate uniform data in terms of encoding, format, and data types. The machine learning algorithm 160 may be executed to run user queries and advanced analytical tools on the structured data. The machine learning algorithm 160 may be configured to generate the one or more artificial intelligence commands 158 based on current usage of the network resources 166 in the communication sites and/or existing instructions 132. In turn, the server processor 122 may be configured to generate the assignments 152 dynamically based on the outputs of the machine learning algorithm 160. The artificial intelligence commands 158 may be parameters that modify the allocation and/or assignment of the network resources 166 in the assignments 152. The artificial intelligence commands 158 may be combined with the existing instructions 132 to create the dynamic instructions and/or configuration commands. In one or more embodiments, the dynamic instructions and/or configuration commands may be dynamically generated updates for the existing instructions 132.

In some embodiments, the machine learning algorithm 160 may be configured to generate and/or train one or more machine learning models that preemptively modify the assignments 152 based at least in part upon the usage of the network resources 166 in the virtual containers 104 and/or the containerized environments 105. In some embodiments, the server 102 may be configured to generate a library of machine learning models categorized in accordance with one or more categories and/or characteristics. The one or more categories and/or characteristics may comprise morphology, spectrum deployed, traffic utilization, services offered, broadband, voice, mission critical, strict SLAs, and the like. One or more of the machine learning models may be configured with attributes that are priority elements for each of the services performed at the communication cell, air interface capacity per cell, and/or numbers of network resources 166 associated with a specific Quality of Service (QOS). In some embodiments, the machine learning models may be created and maintained based at least in part upon one or more different characteristics. After a period of time, the machine learning algorithm 160 following an existing machine learning model may be configured to generate one or more artificial intelligence commands 158 that trigger changes in the allocation of the network resources 166.

The communication conditions 162 may be one or more configuration parameters configured to provide guidelines and/or information to inform the analyses performed by the server processor 122. The communication conditions 162 may be updated periodically over time. The communication conditions 162 may be updated dynamically over time. The communication conditions 162 may be guidelines to analyze current network resource availability information 150 and the historical data 156.

The one or more reports 164 may be communications or messages configured to indicate information to one or more of the network components 118, the base stations 161, and/or the user equipment 114.

The network resources 166 may be power resources, memory resources, and/or processing resources that are consumed in the communication system 100 to communicate in one or more data networks 108 using a communication spectrum. The network resources 166 may be power resources and/or frequency resources in the communication spectrum used as a basis to perform one or more communication operations in one or more communication sites.

The one or more containerized environments 105 may be one or more virtual spaces in which one or more virtual containers 104 may be deployed to enable operations of one or more communication operations in the communication system 100. The virtual containers 104 may be one or more pods configured to be deployed in a containerized environment (e.g., Kubernetes environment). The virtual containers 104 may comprise network resources that are co-located and co-scheduled. The virtual containers 104 may be configured as redundancies of one another or as standalone portions of a wireless communication network. Herein, the systems and methods may be configured to dynamically assign the network resources during maintenance windows. Further, the systems and methods may be configured to dynamically assign the network resources outside of maintenance windows.

### User Equipment

In one or more embodiments, each of the user equipment 114 (e.g., the user equipment 114a and a user equipment 114g representative of the user equipment 114a-114g) may be any computing device configured to communicate with other devices, such as the server 102, other network components 118 in the core network 110, databases, and the like in the communication system 100. Each of the user equipment 114 may be configured to perform specific functions described herein and interact with one or more network components 118 in the core network 110 via one or more base stations 161. Examples of user equipment 114 comprise, but are not limited to, a laptop, a computer, a smartphone, a tablet, a smart device, an IoT device, a simulated reality device, an augmented reality device, or any other suitable type of device.

In one or more embodiments, referring to the user equipment 114a as a non-limiting example of the user equipment 114, the user equipment 114a may comprise a user equipment (UE) network interface 170, a UE I/O interface 172, a UE processor 174 configured to execute a UE processing engine 176, and a UE memory 178 comprising one or more UE instructions 180. The UE network interface 170 may be any suitable hardware or software (e.g., executed by hardware) to facilitate any suitable type of communication in wireless or wired connections. These connections may comprise, but not be limited to, all or a portion of network connections coupled to additional network components 118 in the core network 110, the RAN 112, the Internet, an Intranet, a private network, a public network, a peer-to-peer network, the public switched telephone network, a cellular network, a local area network (LAN), a metropolitan area network (MAN), a wide area network (WAN), and a satellite network. The UE network interface 170 may be configured to support any suitable type of communication protocol.

The UE I/O interface 172 may be hardware configured to perform one or more communication operations 300 described in reference to FIG. 3. The UE I/O interface 172 may comprise one or more antennas as part of a transceiver, a receiver, or a transmitter for communicating using one or more wireless communication protocols or technologies. In some embodiments, the UE I/O interface 172 may be configured to communicate using, for example, 5G NR or LTE using at least some shared radio components. In other embodiments, the UE I/O interface 172 may be configured to communicate using single or shared RF bands. The RF bands may be coupled to a single antenna, or may be coupled to multiple antennas (e.g., for a MIMO configuration) to perform wireless communications. In some embodiments, the user equipment 114a may comprise capabilities for voice communication, mobile broadband services (e.g., video streaming, navigation, and the like), or other types of applications. In this regard, the UE I/O interface 172 of the user equipment 114a may communicate using machine-to-machine (M2M) communication, such as machine-type communication (MTC), or another type of M2M communication.

In some embodiments, the user equipment 114a is communicatively coupled to one or more of the base stations 161 via one or more communication links 116 (e.g., the communication link 116a and the communication link 116g representative of the communication links 116). The user equipment 114a may be a device with cellular communication capability such as a mobile phone, a hand-held device, a computer, a laptop, a tablet, a smart watch or other wearable device, or virtually any type of wireless device. In some applications, the user equipment 114 may be referred to as a UE, UE device, or terminal.

The UE processor 174 may comprise one or more processors operably coupled to and in signal communication with the UE network interface 170, the UE I/O interface 172, and the UE memory 178. The UE processor 174 is any electronic circuitry, including, but not limited to, state machines, one or more CPU chips, logic units, cores (e.g., a multi-core processor), FPGAs, ASICs, or DSPs. The UE processor 174 may be a programmable logic device, a microcontroller, a microprocessor, or any suitable combination of the preceding. The one or more processors in the UE processor 174 are configured to process data and may be implemented in hardware or software executed by hardware. For example, the UE processor 174 may be an 8-bit, a 16-bit, a 32-bit, a 64-bit, or any other suitable architecture. The UE processor 174 comprises an ALU to perform arithmetic and logic operations, processor registers that supply operands to the ALU, and store the results of ALU operations, and a control unit that fetches software instructions such as the UE instructions 180 from the UE memory 178 and executes the UE instructions 180 by directing the coordinated operations of the ALU, registers, and other components via the UE processing engine 176. The UE processor 174 may be configured to execute various instructions. For example, the UE processor 174 may be configured to execute the UE instructions 180 to implement functions or perform operations disclosed herein, such as some or all of those described with respect to FIGS. 1-5. In some embodiments, the functions described herein are implemented using logic units, FPGAs, ASICs, DSPs, or any other suitable hardware or electronic circuitry.

### Radio Access Network

In one or more embodiments, the RAN 112 enables the user equipment 114 to access one or more services in the core network 110. The one or more services may be a mobile telephone service, a Short Message Service (SMS) message service, a Multimedia Message Service (MMS) message service, an Internet access, cloud computing, or other types of data services. The RAN 112 may comprise the base stations 161 in signal communication with the user equipment 114 via the one or more communication links 116. Each of the base stations 161 may service the user equipment 114. In some embodiments, while multiple base stations 161 are shown connected to multiple user equipment 114 via the communication link 116, one or more additional base stations 161 may be connected to one or more additional user equipment 114 via one or more additional communication links 116. For example, the base station 161a-161g may exchange connectivity signals with the user equipment 114a via the communication link 116a. In another example, the base station 161g may exchange connectivity signals with the user equipment 114g via the communication link 116g. In yet another example, the base stations 161 may service some user equipment 114 located within a geographic area serviced by one of the base stations 161.

In one or more embodiments, referring to the base station 161a as a non-limiting example of the base station 161, the base station 161a may comprise a base station (BS) network interface 182, a BS I/O interface 184, a BS processor 186, and a BS memory 188. The BS network interface 182 may be any suitable hardware or software (e.g., executed by hardware) to facilitate any suitable type of communication in wireless or wired connections between the core network 110 and the user equipment 114. These connections may comprise, but not be limited to, all or a portion of network connections coupled to additional network components 118 in the core network 110, other base stations 161, the user equipment 114, the Internet, an Intranet, a private network, a public network, a peer-to-peer network, the public switched telephone network, a cellular network, a LAN, a MAN, a WAN, and a satellite network. The BS network interface 182 may be configured to support any suitable type of communication protocol.

The BS I/O interface 184 may comprise one or more antennas as part of a transceiver, a receiver, or a transmitter for communicating using one or more wireless communication protocols or technologies. In some embodiments, the BS I/O interface 184 may be configured to communicate using, for example, 5G NR or LTE using at least some shared radio components. In other embodiments, the BS I/O interface 184 may be configured to communicate using single or shared RF bands. The RF bands may be coupled to a single antenna, or may be coupled to multiple antennas (e.g., for a MIMO configuration) to perform wireless communications. In some embodiments, the base station 161a may allocate resources in accordance with one or more routing and configuration operations obtained from the core network 110. In some embodiments, resources may be allocated to enable capabilities in the user equipment 114 for voice communication, mobile broadband services (e.g., video streaming, navigation, and the like), or other types of applications.

In some embodiments, the base station 161a is communicatively coupled to one or more of the user equipment 114 via the one or more communication links 116. In some applications, the base stations 161a may be referred to as BS, evolved Node B (eNodeB or eNB), a next generation Node B, gNodeB, gNB, or terminal.

The BS processor 186 may comprise one or more processors operably coupled to and in signal communication with the BS network interface 182, the BS I/O interface 184, and the BS memory 188. The BS processor 186 is any electronic circuitry, including, but not limited to, state machines, one or more CPU chips, logic units, cores (e.g., a multi-core processor), FPGAs, ASICs, or DSPs. The BS processor 186 may be a programmable logic device, a microcontroller, a microprocessor, or any suitable combination of the preceding. The one or more processors in the BS processor 186 are configured to process data and may be implemented in hardware or software executed by hardware. For example, the BS processor 186 may be an 8-bit, a 16-bit, a 32-bit, a 64-bit, or any other suitable architecture. The BS processor 186 comprises an ALU to perform arithmetic and logic operations, processor registers that supply operands to the ALU, and store the results of ALU operations, and a control unit that fetches software instructions (not shown) from the BS memory 188 and executes the software instructions by directing the coordinated operations of the ALU, registers, and other components via a processing engine (not shown) in the BS processor 186. The BS processor 186 may be configured to execute various instructions. For example, the BS processor 186 may be configured to execute the software instructions to implement functions or perform operations disclosed herein, such as some or all of those described with respect to FIGS. 1-5. In some embodiments, the functions described herein are implemented using logic units, FPGAs, ASICs, DSPs, or any other suitable hardware or electronic circuitry.

### Core Network

The core network 110 may be a network configured to manage communication sessions for the user equipment 114. In one or more embodiments, the core network 110 may establish connections between user equipment 114 and a particular data network 108 in accordance with one or more communication protocols. In the example of FIG. 1, the core network 110 comprises one or more network components configured to perform one or more NFs. In some embodiments, the core network 110 enables the user equipment 114 to communicate with the server 102, or another type of device, located in a particular data network 108 or in signal communication with a particular data network 108. The core network 110 may implement a communication method that does not require the establishment of a specific communication protocol connection between the user equipment 114 and one or more of the data networks 108. The core network 110 may include one or more types of network devices (not shown), which may perform different NFs.

In some embodiments, the core network 110 may include a 5G NR or an LTE access network (e.g., an evolved packet core (EPC) network) among others. In this regard, the core network 110 may comprise one or more logical networks implemented via wireless connections or wired connections. Each logical network may comprise an end-to-end virtual network with dedicated power, storage, or computation resources. Each logical network may be configured to perform a specific application comprising individual policies, rules, or priorities. Further, each logical network may be associated with a particular Quality of Service (QoS) class, type of service, or particular user associated with one or more of the user equipment 114. For example, a logical network may be a Mobile Private Network (MPN) configured for a particular organization. In this example, when the user equipment 114a is configured and activated by a wireless network associated with the RAN 112, the user equipment 114a may be configured to connect to one or more particular network slices (i.e., logical networks) in the core network 110. Any logical networks or slices that may be configured for the user equipment 114a may be configured using a network component (e.g., one of the network components 118 (e.g., the network component 118a, the network component 118b, and the network component 118g representing the network component 118a-118g) of FIG. 1.

In one or more embodiments, each of the network components 118 may comprise a component processor 192 configured to perform one or more similar operations to those described in reference to the BS processor 186 and the UE processor 174. In other embodiments, each of the network components 118 may comprise a component memory 194 configured to perform one or more similar operations to those described in reference to the BS memory 188 and the UE memory 178.

### Data Networks

In the example system 100 of FIG. 1, the data networks 108 may facilitate communication within the communication system 100. This disclosure contemplates that the data networks 108 may be any suitable network operable to facilitate communication between the server 102, the core network 110, the RAN 112, and the user equipment 114. The data networks 108 may include any interconnecting system capable of transmitting audio, video, signals, data, messages, or any combination of the preceding. The data networks 108 may include all or a portion of a LAN, a WAN, an overlay network, a software-defined network (SDN), a virtual private network (VPN), a packet data network (e.g., the Internet), a mobile telephone network (e.g., cellular networks, such as 4G or 5G), a Plain Old Telephone (POT) network, a wireless data network (e.g., WiFi, WiGig, WiMax, and the like), a Long Term Evolution (LTE) network, a Universal Mobile Telecommunications System (UMTS) network, a peer-to-peer (P2P) network, a Bluetooth network, a Near Field Communication network, a Zigbee network, or any other suitable network, operable to facilitate communication between the components of the communication system 100. In other embodiments, the communication system 100 may not have all of these components or may comprise other elements instead of, or in addition to, those above.

### Dynamic Horizontal Scaling

FIGS. 2A-2D show respective virtual container scaling cycles 200a-200d in which the communication system 100 is configured to dynamically perform one or more dynamic horizontal scaling operations 103, in accordance with one or more embodiments. In FIGS. 2A-2D, one or more states 210 are shown for multiple virtual containers 104a-104c for multiple periods of time (e.g., a period of time T0, a period of time T1, a period of time T2, and a period of time T3). In some embodiments, the scaling operations 103 modify, add, and/or replace one or more of the virtual containers 104a-104c over the periods of time T0-T3. FIGS. 2C and 2D comprise alternative transitions from the period of time T2 to the period of time T3.

In one or more embodiments, the virtual containers 104a-104c are examples of possible virtual containers 104 comprising network resources 166 assigned during a maintenance window or outside a maintenance window. The virtual containers 104a-104c may comprise a same size. In some embodiments, the virtual containers 104a-104c may be allocated in different order and/or different containerized environments 105. Each of the virtual containers 104a-104c comprises a corresponding processor allocation 222 and a corresponding memory allocation 224. The virtual containers 104a-104c may be located in one or more containerized environments 105.

In FIG. 2A, the virtual container scaling cycle 200a comprises scaling operations 103 in which the virtual container 104a is dynamically scaled horizontally to use additional network resources 166. The virtual container scaling cycle 200a transitions a virtual container 104a in the period of time T0 to two virtual containers 104a and 104b in the period of time T1. Herein, dynamic horizontal scaling comprises adding the virtual container 104b to resemble network resources 166 allocated in the virtual container 104a.

At the period of time T0, a current state 210a of the one or more containerized environments 105 comprises the virtual container 104a comprising a processor allocation 222a and a memory allocation 224a. During the period of time T0, the server 102 may be configured to execute the machine learning algorithms 160 to evaluate current network resource availability information 150 and/or historical data 156 to determine one or more network assignment recommendations 154. In some embodiments, the network assignment recommendations 154 indicate that the period of time T1 comprises at least twice a number of network resources 166 available than a number of resources currently available in the period of time T0. At this stage, the server 102 may be configured to generate one or more assignments 152 to double the number of virtual containers 104 in the one or more containerized environments 105. In some embodiments, the server 102 is configured to evaluate whether the one or more communication conditions 162 are met to generate the one or more assignments 152. For example, the server 102 may be configured to determine that no assignments 152 are generated even though there are twice as many network resources 166 available in the period of time T1 if the communication system 100 does not require and/or may not benefit from doubling the number of virtual containers 104 in the one or more containerized environments 105. In another example, the server 102 may be configured to determine that the assignments 152 are generated because the communication system 100 is expected to require and/or may benefit from doubling the number of virtual containers 104 in the one or more containerized environments 105. In this example, the network resources 166 may be redistributed from other virtual containers 104 (not shown in FIG. 2A) to meet the demands at the one or more containerized environments 105 of FIG. 2A at the period of time T1.

At the period of time T1, a next state 210b of the one or more containerized environments 105 is shown comprising the virtual container 104a with the processor allocation 222a and the memory allocation 224a and a virtual container 104b comprising a processor allocation 222b and a memory allocation 224b. In the transition from the period of time T0 to the period of time T1, the scaling operations 103 scale-out the virtual containers 104 in the one or more containerized environments 105 based on consumption demands determined for the period of time T1 at the period of time T0.

In FIG. 2B, the virtual container scaling cycle 200b comprises scaling operations 103 in which the virtual container 104a and the virtual container 104b are dynamically scaled horizontally to use additional network resources 166. The virtual container scaling cycle 200b transitions the virtual container 104a and the virtual container 104b in the period of time T1 to three virtual containers 104a-104c in the period of time T2. Herein, dynamic horizontal scaling comprises adding the virtual container 104c to resemble network resources 166 allocated in the virtual container 104a and/or the virtual container 104b.

At the period of time T1, a current state 210b of the one or more containerized environments 105 comprises the virtual container 104a comprising the processor allocation 222a and the memory allocation 224a and the virtual container 104b comprising the processor allocation 222b and the memory allocation 224b. During the period of time T1, the server 102 may be configured to execute the machine learning algorithms 160 to evaluate current network resource availability information 150 and/or historical data 156 to determine one or more network assignment recommendations 154. In some embodiments, the network assignment recommendations 154 indicate that the period of time T2 comprises at least one and a half a number of network resources 166 available than a number of resources currently available in the period of time T1. At this stage, the server 102 may be configured to generate one or more assignments 152 to increase the number of virtual containers 104 in the one or more containerized environments 105. In some embodiments, the server 102 is configured to evaluate whether the one or more communication conditions 162 are met to generate the one or more assignments 152. For example, the server 102 may be configured to determine that no assignments 152 are generated even though there are one and a half as many network resources 166 available in the period of time T2 if the communication system 100 does not require and/or may not benefit from increasing the number of virtual containers 104 in the one or more containerized environments 105. In another example, the server 102 may be configured to determine that the assignments 152 are generated because the communication system 100 is expected to require and/or may benefit from increasing the number of virtual containers 104 in the one or more containerized environments 105. In this example, the network resources 166 may be redistributed from other virtual containers 104 (not shown in FIG. 2B) to meet the demands at the one or more containerized environments 105 of FIG. 2B at the period of time T2.

At the period of time T2, a next state 210c of the one or more containerized environments 105 is shown comprising the virtual container 104a with the processor allocation 222a and the memory allocation 224a, the virtual container 104b comprising the processor allocation 222b and the memory allocation 224b, and a virtual container 104c comprising a processor allocation 222c and a memory allocation 224c. In the transition from the period of time T1 to the period of time T2, the scaling operations 103 scale-out the virtual containers 104 in the one or more containerized environments 105 based on consumption demands determined for the period of time T2 at the period of time T1.

In FIG. 2C, the virtual container scaling cycle 200c comprises scaling operations 103 in which the virtual container 104a, the virtual container 104b, and the virtual container 104c are dynamically scaled horizontally to use less network resources 166. The virtual container scaling cycle 200c transitions the virtual container 104a, the virtual container 104b, and the virtual container 104c in the period of time T2 to two virtual containers 104a and 104b in the period of time T3. Herein, dynamic horizontal scaling comprises removing the virtual container 104c that resembled network resources 166 allocated in the virtual container 104a and/or the virtual container 104b.

At the period of time T2, a current state 210c of the one or more containerized environments 105 comprises the virtual container 104a comprising a processor allocation 222a and a memory allocation 224a, the virtual container 104b comprising a processor allocation 222b and a memory allocation 224b, and the virtual container 104c comprising a processor allocation 222c and a memory allocation 224c. During the period of time T2, the server 102 may be configured to execute the machine learning algorithms 160 to evaluate current network resource availability information 150 and/or historical data 156 to determine one or more network assignment recommendations 154. In some embodiments, the network assignment recommendations 154 indicate that the period of time T3 comprises two thirds of a number of network resources 166 available than a number of resources currently available in the period of time T2. At this stage, the server 102 may be configured to generate one or more assignments 152 to reduce the number of virtual containers 104 in the one or more containerized environments 105. In some embodiments, the server 102 is configured to evaluate whether the one or more communication conditions 162 are met to generate the one or more assignments 152. For example, the server 102 may be configured to determine that the assignments 152 are generated because the communication system 100 is expected to require and/or may benefit from reducing a number of virtual containers 104 in the one or more containerized environments 105. In this example, the network resources 166 may be redistributed to other virtual containers 104 (not shown in FIG. 2C) to meet the demands at the one or more containerized environments 105 of FIG. 2C at the period of time T3.

At the period of time T3, a next state 210d of the one or more containerized environments 105 is shown comprising the virtual container 104a with the processor allocation 222a and the memory allocation 224a and the virtual container 104b comprising the processor allocation 222b and the memory allocation 224b. In the transition from the period of time T2 to the period of time T3 in FIG. 2C, the scaling operations 103 scale-in the virtual containers 104 in the one or more containerized environments 105 based on consumption demands determined for the period of time T3 at the period of time T2.

In FIG. 2D, the virtual container scaling cycle 200d comprises scaling operations 103 in which the virtual container 104a, the virtual container 104b, and the virtual container 104c are dynamically scaled horizontally to use less network resources 166. The virtual container scaling cycle 200d transitions the virtual container 104a, the virtual container 104b, and the virtual container 104c in the period of time T2 to one virtual container 104a in the period of time T3. Herein, dynamic horizontal scaling comprises removing the virtual container 104b and the virtual container 104c that resembled network resources 166 allocated in the virtual container 104a.

At the period of time T2, a current state 210c of the one or more containerized environments 105 comprises the virtual container 104a comprising a processor allocation 222a and a memory allocation 224a, the virtual container 104b comprising a processor allocation 222b and a memory allocation 224b, and the virtual container 104c comprising a processor allocation 222c and a memory allocation 224c. During the period of time T2, the server 102 may be configured to execute the machine learning algorithms 160 to evaluate current network resource availability information 150 and/or historical data 156 to determine one or more network assignment recommendations 154. In some embodiments, the network assignment recommendations 154 indicate that the period of time T3 comprises one third of a number of network resources 166 available than a number of resources currently available in the period of time T2. At this stage, the server 102 may be configured to generate one or more assignments 152 to reduce the number of virtual containers 104 in the one or more containerized environments 105. In some embodiments, the server 102 is configured to evaluate whether the one or more communication conditions 162 are met to generate the one or more assignments 152. For example, the server 102 may be configured to determine that the assignments 152 are generated because the communication system 100 is expected to require and/or may benefit from reducing a number of virtual containers 104 in the one or more containerized environments 105. In this example, the network resources 166 may be redistributed to other virtual containers 104 (not shown in FIG. 2D) to meet the demands at the one or more containerized environments 105 of FIG. 2D at the period of time T3.

At the period of time T3, a next state 210d of the one or more containerized environments 105 is shown comprising the virtual container 104a with the processor allocation 222a and the memory allocation 224a. In the transition from the period of time T2 to the period of time T3 in FIG. 2D, the scaling operations 103 scale-in the virtual containers 104 in the one or more containerized environments 105 based on consumption demands determined for the period of time T3 at the period of time T2.

### Dynamic Vertical Scaling

FIGS. 3A-3D show respective virtual container scaling cycles 300a-300d in which the communication system 100 is configured to dynamically perform one or more dynamic vertical scaling operations 103, in accordance with one or more embodiments. In FIGS. 3A-3D, one or more states 310 are shown for multiple virtual containers 104e and 104f for multiple periods of time (e.g., a period of time T0, a period of time T1, a period of time T2, and a period of time T3). In some embodiments, the scaling operations 103 modify, add, and/or replace one or more of network resources 166 allocated to a virtual container 104e and a virtual container 104d over the periods of time T0-T3. FIGS. 3C and 3D comprise alternative transitions from the period of time T2 to the period of time T3.

In one or more embodiments, the virtual container 104e and the virtual container 104f are examples of possible virtual containers 104 comprising network resources 166 assigned during a maintenance window or outside a maintenance window. The virtual container 104c and the virtual container 104f may comprise a same size or different sizes over time. In some embodiments, the virtual container 104e and the virtual container 104f may be allocated in different order and/or different containerized environments 105. Each of the virtual container 104e and the virtual container 104f comprises a corresponding processor allocation 222 and a corresponding memory allocation 224. The virtual container 104e and the virtual container 104f may be located in one or more containerized environments 105.

In FIG. 3A, the virtual container scaling cycle 300a comprises scaling operations 103 in which the virtual container 104c is dynamically scaled vertically to use additional network resources 166. The virtual container scaling cycle 300a transitions a virtual container 104e in the period of time T0 to add processing network resources 166 and memory network resources in the period of time T1. Further, the virtual container scaling cycle 300a does not transition a virtual container 104f in the period of time T0.

At the period of time T0, a current state 310a of the one or more containerized environments 105 comprises the virtual container 104e comprising a processor allocation 222e and a memory allocation 224e and the virtual container 104f comprising a processor allocation 222f and a memory allocation 224f. Herein, the processor allocation 222e is shown comprising a number “n” of processing network resources 166, the memory allocation 224e is shown comprising a number “m” of processing network resources 166, the processor allocation 222f is shown comprising a number “n” of processing network resources 166, and the memory allocation 224e is shown comprising a number “m” of processing network resources 166. During the period of time T0, the server 102 may be configured to execute the machine learning algorithms 160 to evaluate current network resource availability information 150 and/or historical data 156 to determine one or more network assignment recommendations 154. In some embodiments, the network assignment recommendations 154 indicate that the period of time T1 comprises a number of network resources 166 available that is greater than a number of resources currently available in the period of time T0. At this stage, the server 102 may be configured to generate one or more assignments 152 to increase the number of network resources 166 in the virtual containers 104e and 104f in the one or more containerized environments 105. In some embodiments, the server 102 is configured to evaluate whether the one or more communication conditions 162 are met to generate the one or more assignments 152. For example, the server 102 may be configured to determine that no assignments 152 are generated even though there are more network resources 166 available in the period of time T1 if the communication system 100 does not require and/or may not benefit from increasing the number of network resources 166 in the virtual containers 104e and 104f in the one or more containerized environments 105. In another example, the server 102 may be configured to determine that the assignments 152 are generated because the communication system 100 is expected to require and/or may benefit from increasing the number of network resources 166 in the virtual containers 104e and 104f in the one or more containerized environments 105. In this example, the network resources 166 may be redistributed from other virtual containers 104 (not shown in FIG. 3A) to meet the demands at the one or more containerized environments 105 of FIG. 3A at the period of time T1.

At the period of time T1, a next state 310b of the one or more containerized environments 105 is shown comprising the virtual container 104e with the processor allocation 222c and the memory allocation 224e and the virtual container 104f comprising the processor allocation 222f and the memory allocation 224f. Herein, the processor allocation 222e is shown comprising a number “n+x” of processing network resources 166, the memory allocation 224e is shown comprising a number “m+y” of processing network resources 166, the processor allocation 222f is shown comprising the number “n” of processing network resources 166, and the memory allocation 224e is shown comprising the number “m” of processing network resources 166. In the transition from the period of time T0 to the period of time T1, the scaling operations 103 scale-up the network resources 166 in the virtual containers 104e and 104f in the one or more containerized environments 105 based on consumption demands determined for the period of time T1 at the period of time T0.

In some embodiments, a number “x” of network resources 166 added to the processor allocation 222e on the period of time T1 may be equal or different to a number “y” of network resources 166 added to the memory allocation 224e on the period of time T1.

In FIG. 3B, the virtual container scaling cycle 300b comprises scaling operations 103 in which the virtual container 104e and the virtual container 104f are dynamically scaled vertically to use additional network resources 166. The virtual container scaling cycle 300b transitions the virtual container 104c and the virtual container 104f in the period of time T1 to comprise additional network resources 166 in the period of time T2. Herein, dynamic vertical scaling comprises adding network resources 166 to the virtual container 104e and the virtual container 104c.

At the period of time T1, a current state 310b of the one or more containerized environments 105 comprises the virtual container 104e comprising the processor allocation 222c and the memory allocation 224c and the virtual container 104f comprising the processor allocation 222f and the memory allocation 224f. During the period of time T1, the server 102 may be configured to execute the machine learning algorithms 160 to evaluate current network resource availability information 150 and/or historical data 156 to determine one or more network assignment recommendations 154. In some embodiments, the network assignment recommendations 154 indicate that the period of time T2 comprises a number of network resources 166 available that is greater than a number of resources currently available in the period of time T1. At this stage, the server 102 may be configured to generate one or more assignments 152 to increase the number of network resources 166 in the virtual containers 104c and 104f in the one or more containerized environments 105. In some embodiments, the server 102 is configured to evaluate whether the one or more communication conditions 162 are met to generate the one or more assignments 152. For example, the server 102 may be configured to determine that no assignments 152 are generated even though there are additional network resources 166 available in the period of time T2 if the communication system 100 does not require and/or may not benefit from increasing the number of network resources 166 in the virtual containers 104e and 104f in the one or more containerized environments 105. In another example, the server 102 may be configured to determine that the assignments 152 are generated because the communication system 100 is expected to require and/or may benefit from increasing the number of network resources 166 in the virtual containers 104c and 104f in the one or more containerized environments 105. In this example, the network resources 166 may be redistributed from other virtual containers 104 (not shown in FIG. 3B) to meet the demands at the one or more containerized environments 105 of FIG. 3B at the period of time T2.

At the period of time T2, a next state 310c of the one or more containerized environments 105 is shown comprising the virtual container 104e with the processor allocation 222e and the memory allocation 224c and the virtual container 104b comprising the processor allocation 222b and the memory allocation 224b. Herein, the processor allocation 222e is shown comprising a number “n+x+b” of processing network resources 166, the memory allocation 224c is shown comprising a number “m+y+c” of processing network resources 166, the processor allocation 222f is shown comprising the number “n+b” of processing network resources 166, and the memory allocation 224e is shown comprising the number “m+c” of processing network resources 166. In the transition from the period of time T1 to the period of time T2, the scaling operations 103 scale-up the network resources 166 in the virtual containers 104c and 104f in the one or more containerized environments 105 based on consumption demands determined for the period of time T2 at the period of time T1.

In some embodiments, a number “b” of network resources 166 added to the processor allocation 222e on the period of time T2 may be equal or different to a number “c” of network resources 166 added to the memory allocation 224e on the period of time T2.

In FIG. 3C, the virtual container scaling cycle 300c comprises scaling operations 103 in which the virtual container 104e and the virtual container 104f are dynamically scaled vertically to use less network resources 166. The virtual container scaling cycle 300c transitions the virtual container 104e and the virtual container 104f in the period of time T2 to comprise additional network resources 166 in the period of time T3. Herein, dynamic vertical scaling comprises removing network resources 166 from the virtual container 104e and the virtual container 104c.

At the period of time T2, a current state 310c of the one or more containerized environments 105 comprises the virtual container 104e comprising the processor allocation 222e and the memory allocation 224c and the virtual container 104f comprising the processor allocation 222f and the memory allocation 224f. During the period of time T2, the server 102 may be configured to execute the machine learning algorithms 160 to evaluate current network resource availability information 150 and/or historical data 156 to determine one or more network assignment recommendations 154. In some embodiments, the network assignment recommendations 154 indicate that the period of time T3 comprises a number of network resources 166 available that is less than a number of resources currently available in the period of time T2. At this stage, the server 102 may be configured to generate one or more assignments 152 to increase the number of network resources 166 in the virtual containers 104c and 104f in the one or more containerized environments 105. In some embodiments, the server 102 is configured to evaluate whether the one or more communication conditions 162 are met to generate the one or more assignments 152. For example, the server 102 may be configured to determine that no assignments 152 are generated even though there are less network resources 166 available in the period of time T3 if the communication system 100 does not require and/or may not benefit from reducing the number of network resources 166 in the virtual containers 104e and 104f in the one or more containerized environments 105. In another example, the server 102 may be configured to determine that the assignments 152 are generated because the communication system 100 is expected to require and/or may benefit from increasing the number of network resources 166 in the virtual containers 104e and 104f in the one or more containerized environments 105. In this example, the network resources 166 may be redistributed from other virtual containers 104 (not shown in FIG. 3C) to meet the demands at the one or more containerized environments 105 of FIG. 3C at the period of time T3.

At the period of time T3, a next state 310d of the one or more containerized environments 105 is shown comprising the virtual container 104e with the processor allocation 222c and the memory allocation 224c and the virtual container 104b comprising the processor allocation 222b and the memory allocation 224b. Herein, the processor allocation 222e is shown comprising a number “n+x” of processing network resources 166 where a number “b” of processing network resources 166 are removed, the memory allocation 224e is shown comprising a number “m+y” of processing network resources 166 where a number “c” of memory network resources 166 are removed, the processor allocation 222f is shown comprising the number “b” of processing network resources 166 where a number “n” of processing network resources 166 are removed, and the memory allocation 224e is shown comprising the number “c” of processing network resources 166 where a number “m” of processing network resources 166 are removed. In the transition from the period of time T2 to the period of time T3, the scaling operations 103 scale-down the network resources 166 in the virtual containers 104e and 104f in the one or more containerized environments 105 based on consumption demands determined for the period of time T3 at the period of time T2.

In some embodiments, a number “b” of network resources 166 removed from the processor allocation 222e on the period of time T3 may be equal or different to a number “c” of network resources 166 removed from the memory allocation 224e on the period of time T3. In other embodiments, a number “n” of network resources 166 removed from the processor allocation 222f on the period of time T3 may be equal or different to a number “m” of network resources 166 removed from the memory allocation 224f on the period of time T3.

In FIG. 3D, the virtual container scaling cycle 300d comprises scaling operations 103 in which the virtual container 104e and the virtual container 104f are dynamically scaled vertically to use less network resources 166. The virtual container scaling cycle 300d transitions the virtual container 104c and the virtual container 104f in the period of time T2 to comprise additional network resources 166 in the period of time T3. Herein, dynamic vertical scaling comprises removing network resources 166 from the virtual container 104e and the virtual container 104c.

At the period of time T2, a current state 310c of the one or more containerized environments 105 comprises the virtual container 104e comprising the processor allocation 222e and the memory allocation 224c and the virtual container 104f comprising the processor allocation 222f and the memory allocation 224f. During the period of time T2, the server 102 may be configured to execute the machine learning algorithms 160 to evaluate current network resource availability information 150 and/or historical data 156 to determine one or more network assignment recommendations 154. In some embodiments, the network assignment recommendations 154 indicate that the period of time T3 comprises a number of network resources 166 available that is less than a number of resources currently available in the period of time T2. At this stage, the server 102 may be configured to generate one or more assignments 152 to increase the number of network resources 166 in the virtual containers 104c and 104f in the one or more containerized environments 105. In some embodiments, the server 102 is configured to evaluate whether the one or more communication conditions 162 are met to generate the one or more assignments 152. For example, the server 102 may be configured to determine that no assignments 152 are generated even though there are less network resources 166 available in the period of time T3 if the communication system 100 does not require and/or may not benefit from reducing the number of network resources 166 in the virtual containers 104c and 104f in the one or more containerized environments 105. In another example, the server 102 may be configured to determine that the assignments 152 are generated because the communication system 100 is expected to require and/or may benefit from increasing the number of network resources 166 in the virtual containers 104c and 104f in the one or more containerized environments 105. In this example, the network resources 166 may be redistributed from other virtual containers 104 (not shown in FIG. 3D) to meet the demands at the one or more containerized environments 105 of FIG. 3D at the period of time T3.

At the period of time T3, a next state 310d of the one or more containerized environments 105 is shown comprising the virtual container 104e with the processor allocation 222e and the memory allocation 224e and the virtual container 104b comprising the processor allocation 222b and the memory allocation 224b. Herein, the processor allocation 222e is shown comprising a number “n+x+b-d” of processing network resources 166 where a number “d” of processing network resources 166 are removed, the memory allocation 224e is shown comprising a number “m+y+c-e” of processing network resources 166 where a number “e” of memory network resources 166 are removed, the processor allocation 222f is shown comprising the number “n” of processing network resources 166 where a number “b” of processing network resources 166 are removed, and the memory allocation 224e is shown comprising the number “m” of processing network resources 166 where a number “c” of processing network resources 166 are removed. In the transition from the period of time T2 to the period of time T3, the scaling operations 103 scale-down the network resources 166 in the virtual containers 104e and 104f in the one or more containerized environments 105 based on consumption demands determined for the period of time T3 at the period of time T2.

In some embodiments, a number “d” of network resources 166 removed from the processor allocation 222e on the period of time T3 may be equal or different to a number “e” of network resources 166 removed from the memory allocation 224e on the period of time T3. The number “d” of network resources 166 removed from the processor allocation 222e on the period of time T3 may be less than or more than the number “x” of processing network resources added to the processor allocation 222e added on the period of time T1. The number “d” of network resources 166 removed from the processor allocation 222e on the period of time T3 may be less than or more than the number “b” of processing network resources added to the processor allocation 222e added on the period of time T2. In other embodiments, a number “b” of network resources 166 removed from the processor allocation 222f on the period of time T3 may be equal or different to a number “c” of network resources 166 removed from the memory allocation 224f on the period of time T3.

### Dynamic Hybrid Scaling

FIGS. 4A and 4B show respective virtual container scaling cycles 400a and 400b in which the communication system 100 is configured to dynamically perform one or more dynamic horizontal scaling operations 103 and/or vertical scaling operations 103, in accordance with one or more embodiments. In FIGS. 4A and 4B, one or more states 410 are shown for multiple virtual containers 104g-104l for multiple periods of time (e.g., a period of time T0, a period of time T1, and a period of time T2). In some embodiments, the scaling operations 103 modify, add, and/or replace one or more of the virtual containers 104g-104l and/or the network resources 166 allocated to the virtual containers 104g-104l over the periods of time T0-T2.

In one or more embodiments, the virtual containers 104g-104l are examples of possible virtual containers 104 comprising network resources 166 assigned during a maintenance window or outside a maintenance window. The virtual containers 104g-1040 may comprise a same size. In some embodiments, the virtual containers 104g-1040 may be allocated in different order and/or different containerized environments 105. Each of the virtual containers 104g-104l comprises a corresponding processor allocation 222 and a corresponding memory allocation 224. The virtual containers 104g-104l may be located in one or more containerized environments 105.

In FIG. 4A, the virtual container scaling cycle 400a comprises scaling operations 103 in which the virtual container 104g is dynamically scaled horizontally and vertically to use additional network resources 166. The virtual container scaling cycle 400a transitions a virtual container 104g in the period of time T0 to three virtual containers 104g, 104h, and 104i in the period of time T1. Herein, dynamic horizontal scaling comprises adding the virtual container 104h and the virtual container 104i to resemble network resources 166 allocated in the virtual container 104g in the period of time T0. Further, dynamic vertical scaling comprises adding network resources 166 to the virtual container 104g in the period of time T1.

At the period of time T0, a current state 410a of the one or more containerized environments 105 comprises the virtual container 104g comprising a processor allocation 222g and a memory allocation 224g. During the period of time T0, the server 102 may be configured to execute the machine learning algorithms 160 to evaluate current network resource availability information 150 and/or historical data 156 to determine one or more network assignment recommendations 154. In some embodiments, the network assignment recommendations 154 indicate that the period of time T1 comprises a number of network resources 166 that is different to a number of resources currently available in the period of time T0. At this stage, the server 102 may be configured to generate one or more assignments 152 to increase the number of network resources 166 in the virtual container 104g and to increase the number of virtual containers 104 in the one or more containerized environments 105. In some embodiments, the server 102 is configured to evaluate whether the one or more communication conditions 162 are met to generate the one or more assignments 152.

At the period of time T1, a next state 410b of the one or more containerized environments 105 is shown comprising the virtual container 104g with the processor allocation 222g and the memory allocation 224g. Herein, the processor allocation 222g is shown comprising a number “n+x” of processing network resources 166 where a number “x” of processing network resources 166 are added and the memory allocation 224e is shown comprising a number “m+y” of processing network resources 166 where a number “y” of memory network resources 166 are added. In the transition from the period of time T0 to the period of time T1, the scaling operations 103 scale-up the virtual container 104g in the one or more containerized environments 105 based on consumption demands determined for the period of time T1 at the period of time T0. In some embodiments, a number “x” of network resources 166 added to the processor allocation 222e on the period of time T1 may be equal or different to a number “y” of network resources 166 added to the memory allocation 224e on the period of time T1.

At the period of time T1, a next state 410c of the one or more containerized environments 105 is shown comprising the virtual container 104h with the processor allocation 222h and the memory allocation 224h and the virtual container 104i with the processor allocation 222i and the memory allocation 224i. Herein, the virtual container 104h of the period of time T1 and the virtual container 104i of the period of time T1 are copies of the virtual container 104g of the period of time T0. In the transition from the period of time T0 to the period of time T1, the scaling operations 103 scale-out the virtual container 104g in the one or more containerized environments 105 based on consumption demands determined for the period of time T1 at the period of time T0.

In FIG. 4B, the virtual container scaling cycle 400b comprises scaling operations 103 in which the virtual container 104g is dynamically scaled horizontally and vertically to reallocate the network resources 166 used in the one or more containerized environments 105. The virtual container scaling cycle 400b transitions a virtual container 104g in the period of time T1 to three virtual containers 104g, 104j, 104k, and 104l in the period of time T2. Herein, dynamic horizontal scaling comprises adding the virtual container 104j, the virtual container 104k, and the virtual container 104l to resemble network resources 166 allocated in the virtual container 104g in the period of time T1. Further, dynamic vertical scaling comprises adding network resources 166 to the virtual container 104g in the period of time T2.

At the period of time T1, a current state 410b of the one or more containerized environments 105 comprises the virtual container 104g comprising a processor allocation 222g and a memory allocation 224g. During the period of time T1, the server 102 may be configured to execute the machine learning algorithms 160 to evaluate current network resource availability information 150 and/or historical data 156 to determine one or more network assignment recommendations 154. In some embodiments, the network assignment recommendations 154 indicate that the period of time T2 comprises a number of network resources 166 that is different to a number of resources currently available in the period of time T1. At this stage, the server 102 may be configured to generate one or more assignments 152 to reduce the number of network resources 166 in the virtual container 104g and to increase the number of virtual containers 104 in the one or more containerized environments 105. In some embodiments, the server 102 is configured to evaluate whether the one or more communication conditions 162 are met to generate the one or more assignments 152.

At the period of time T2, a next state 410d of the one or more containerized environments 105 is shown comprising the virtual container 104g with the processor allocation 222g and the memory allocation 224g. Herein, the processor allocation 222g is shown comprising a number “n+x-b” of processing network resources 166 where a number “b” of processing network resources 166 are removed and the memory allocation 224g is shown comprising a number “m+y-c” of processing network resources 166 where a number “c” of memory network resources 166 are removed. In the transition from the period of time T1 to the period of time T2, the scaling operations 103 scale-down the virtual container 104g in the one or more containerized environments 105 based on consumption demands determined for the period of time T2 at the period of time T1. In some embodiments, a number “b” of network resources 166 removed to the processor allocation 222g on the period of time T2 may be equal or different to a number “c” of network resources 166 removed to the memory allocation 224g on the period of time T2.

At the period of time T2, a next state 410e of the one or more containerized environments 105 is shown comprising the virtual container 104j with the processor allocation 222j and the memory allocation 224j, the virtual container 104k with the processor allocation 222k and the memory allocation 224k, and the virtual container 104l with the processor allocation 222l and the memory allocation 224l. Herein, the virtual container 104j of the period of time T2, the virtual container 104k of the period of time T2, and the virtual container 104l of the period of time T2 are copies of the virtual container 104g of the period of time T1. In the transition from the period of time T1 to the period of time T2, the scaling operations 103 scale-out the virtual container 104g in the one or more containerized environments 105 based on consumption demands determined for the period of time T2 at the period of time T1.

### Example Dynamic Scaling Operations

FIG. 5 illustrate an example flowchart of the process 500 to dynamically scale virtual containers 104 in a containerized environment 105, in accordance with one or more embodiments. Modifications, additions, or omissions may be made to the process 500. The process 500 may include more, fewer, or other operations than those shown above. For example, operations may be performed in parallel or in any suitable order. While at times discussed as the server 102, one or more of the network components 118, one or more of the base stations 161, components of any of thereof, or any suitable system or components of the communication system 100 may perform one or more operations of the process 500. For example, one or more operations of the process 500 may be implemented, at least in part, in the form of server instructions 132 of FIG. 1, stored on non-transitory, tangible, machine-readable media (e.g., server memory 130 of FIG. 1 operating as a non-transitory computer-readable medium) that when run by one or more processors (e.g., the server processor 122 of FIG. 1) may cause the one or more processors to perform operations described in operations 502-542.

In one or more embodiments, the server 102 may be configured to dynamically scale (and/or rescale) usage of network resources at a communication network using current network resource consumption information, historical network resource consumption data (e.g., the historical data 156), and dynamic information of a given communication network. The server 102 may be configured to dynamically expand and/or reduce network resources 166 assigned to virtual containers 104 in one or more containerized environments 105. The network resources 166 in the virtual containers 104 and/or the virtual containers 104 may be expanded and/or reduced simultaneously and/or over time. For example, first virtual containers 104 in a given containerized environments configured to perform first communication operations may be scaled down while second virtual containers 104 in the given containerized environments configured to perform second communication operations may be scaled up. In another example, third virtual containers 104 in the given containerized environments configured to perform third communication operations may be scaled out while fourth virtual containers 104 in the given containerized environments configured to perform fourth communication operations may be scaled in.

The process 500 starts at operation 502, where the server 102 is configured to determine network resource availability information 150 in a communication network. The process 500 may comprise obtaining a machine learning algorithm 160 configured, when executed, to analyze and structure information about network resources 166 assigned in a containerized environment 105 and obtaining historical data 156 representative of one or more network resources 166 assigned in the containerized environment 105 over a first time period.

The process 500 continues at operation 510, where the server 102 determines whether there are network resources 166 available to rescale one or more containerized environments 105. Herein, the process 500 may determine any demands for reallocating the network resources 166 in the containerized environments 105. In response, if the server 102 determines that there are no network resources 166 available to rescale the one or more containerized environments 105 (i.e., NO), the process 500 proceeds to operation 522. In this case, the process 500 may conclude at operation 522, where the server 102 is configured to generate a report 164 indicating that there are no sufficient network resources 166 to rescale the virtual containers 104. If the server 102 determines that there are network resources 166 available to rescale the one or more virtual containers 104 (i.e., YES), the process 500 proceeds to operation 532. At operation 532, where the server 102 is configured after executing the machine learning algorithm 160, analyze the network resource availability information 150 based at least in part upon one or more communication conditions 162.

The process 500 may conclude at operations 534-542, where the server 102 is configured to perform one or more of the rescaling operations 103 described in reference to FIGS. 2A-4B. At operation 534, the server 102 is configured to in response to analyzing the network resource availability information 150, generate one or more analysis results 142. At operation 536, the server 102 is configured to, after executing the machine learning algorithm, generate multiple network assignment recommendations 154 based at least in part upon the analysis results 142 and the historical data 156. At operation 538, the server 102 is configured to assign multiple network resources 166 in the containerized environment 105. Herein, the process 500 may comprise assigning one or more network resources 166 in the containerized environment 105 over a second time period. At operation 542, the server 102 is configured to rescale one or more virtual containers 104 in the containerized environment 105. In some embodiments, the one or more virtual containers 104 are rescaled vertically and/or horizontally in the containerized environment 105 over a same period of time.

### Scope of the Disclosure

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. An apparatus, comprising:
a memory operable to store:
a machine learning algorithm configured, when executed, to analyze and structure information about resources assigned in a containerized environment; and
historical data representative of one or more network resources assigned in the containerized environment over a first time period; and
a processor communicatively coupled to the memory and configured to:
determine first network resource availability information in a communication network, the first network resource availability information indicating first network resources available for assignment in the containerized environment over a second time period;
execute the machine learning algorithm to:
analyze the first network resource availability information based at least in part upon a first plurality of communication conditions;
in response to analyzing the first network resource availability information, generate a first plurality of analysis results; and
generate a first plurality of network assignment recommendations based at least in part upon the first plurality of analysis results and the historical data;
assign a second plurality of resources in the containerized environment over the second time period; and
rescale one or more virtual containers in the containerized environment to use the second plurality of resources.

2. The apparatus of claim 1, wherein:
the one or more virtual containers are rescaled vertically and horizontally in the containerized environment.

3. The apparatus of claim 2, wherein:
a first virtual container of the one or more virtual containers comprises a plurality of processing resources and a plurality of memory resources; and
in conjunction with rescaling the one or more virtual containers vertically, the processor is further configured to:
increase the plurality of processing resources by a first number; and
increase the plurality of processing resources by a second number.

4. The apparatus of claim 3, wherein the processor is further configured to:
determine second network resource availability information in the communication network, the second network resource availability information indicating network resources available for assignment in the containerized environment over a third time period;
execute the machine learning algorithm to:
analyze the second network resource availability information based at least in part upon a second plurality of communication conditions;
in response to analyzing the second network resource availability information, generate a second plurality of analysis results; and
generate a second plurality of network assignment recommendations based at least in part upon the second plurality of analysis results and the historical data;
assign a third plurality of resources in the containerized environment over the third time period;
rescale the first virtual container vertically to use the third plurality of resources; and
in conjunction with rescaling the first virtual container vertically:
reduce the plurality of processing resources by a third number, the third number being equal to the first number; and
reduce the plurality of processing resources by a fourth number, the fourth number being equal to the second number.

5. The apparatus of claim 3, wherein the processor is further configured to:
determine second network resource availability information in the communication network, the second network resource availability information indicating second network resources available for assignment in the containerized environment over a third time period;
execute the machine learning algorithm to:
analyze the second network resource availability information based at least in part upon a second plurality of communication conditions;
in response to analyzing the second network resource availability information, generate a second plurality of analysis results; and
generate a second plurality of network assignment recommendations based at least in part upon the second plurality of analysis results and the historical data;
assign a third plurality of resources in the containerized environment over the third time period;
rescale the first virtual container vertically to use the third plurality of resources; and
in conjunction with rescaling the first virtual container vertically:
reduce the plurality of processing resources by a third number, the third number being less than the first number; and
reduce the plurality of processing resources by a fourth number, the fourth number being less than the second number.

6. The apparatus of claim 2, wherein:
the one or more virtual containers comprise a first virtual container comprising a first number of network resources; and
in conjunction with rescaling the one or more virtual containers horizontally, the processor is further configured to:
create a second virtual container comprising a second number of network resources, the second number of network resources being equal to the first number of network resources; and
create a third virtual container comprising a third number of network resources, the third number of network resources being equal to the second number of network resources.

7. The apparatus of claim 6, wherein the processor is further configured to:
determine second network resource availability information in the communication network, the second network resource availability information indicating second network resources available for assignment in the containerized environment over a third time period;
execute the machine learning algorithm to:
analyze the second network resource availability information based at least in part upon a second plurality of communication conditions;
in response to analyzing the second network resource availability information, generate a second plurality of analysis results; and
generate a second plurality of network assignment recommendations based at least in part upon the second plurality of analysis results and the historical data;
assign a third plurality of resources in the containerized environment over the third time period;
rescale the first virtual container, the second virtual container, and the third virtual container horizontally to use the third plurality of resources; and
in conjunction with rescaling the first virtual container, the second virtual container, and the third virtual container horizontally, discard the second virtual container and the third virtual container.

8. The apparatus of claim 6, wherein the processor is further configured to:
determine second network resource availability information in the communication network, the second network resource availability information indicating second network resources available for assignment in the containerized environment over a third time period;
execute the machine learning algorithm to:
analyze the second network resource availability information based at least in part upon a second plurality of communication conditions;
in response to analyzing the second network resource availability information, generate a second plurality of analysis results; and
generate a second plurality of network assignment recommendations based at least in part upon the second plurality of analysis results and the historical data;
assign a third plurality of resources in the containerized environment over the third time period;
rescale the first virtual container, the second virtual container, and the third virtual container horizontally to use the third plurality of resources; and
in conjunction with rescaling the first virtual container, the second virtual container, and the third virtual container horizontally, discard the third virtual container.

9. A method, comprising:
obtaining a machine learning algorithm configured, when executed, to analyze and structure information about resources assigned in a containerized environment;
obtaining historical data representative of one or more network resources assigned in the containerized environment over a first time period;
determining first network resource availability information in a communication network, the first network resource availability information indicating first network resources available for assignment in the containerized environment over a second time period;
execute the machine learning algorithm to perform one or more operations comprising:
analyzing the first network resource availability information based at least in part upon a first plurality of communication conditions;
in response to analyzing the first network resource availability information, generating a first plurality of analysis results; and
generating a first plurality of network assignment recommendations based at least in part upon the first plurality of analysis results and the historical data;
assigning a second plurality of resources in the containerized environment over the second time period; and
rescaling one or more virtual containers in the containerized environment to use the second plurality of resources.

10. The method of claim 9, wherein:
the one or more virtual containers are rescaled vertically and horizontally in the containerized environment.

11. The method of claim 10, wherein:
a first virtual container of the one or more virtual containers comprises a plurality of processing resources and a plurality of memory resources; and
in conjunction with rescaling the one or more virtual containers vertically, further comprising:
increasing the plurality of processing resources by a first number; and
increasing the plurality of processing resources by a second number.

12. The method of claim 11, further comprising:
determining second network resource availability information in the communication network, the second network resource availability information indicating network resources available for assignment in the containerized environment over a third time period;
execute the machine learning algorithm to perform one or more additional operations comprising:
analyzing the second network resource availability information based at least in part upon a second plurality of communication conditions;
in response to analyzing the second network resource availability information, generating a second plurality of analysis results; and
generating a second plurality of network assignment recommendations based at least in part upon the second plurality of analysis results and the historical data;
assigning a third plurality of resources in the containerized environment over the third time period;
rescaling the first virtual container vertically to use the third plurality of resources; and
in conjunction with rescaling the first virtual container vertically:
reducing the plurality of processing resources by a third number, the third number being equal to the first number; and
reducing the plurality of processing resources by a fourth number, the fourth number being equal to the second number.

13. The method of claim 11, further comprising:
determining second network resource availability information in the communication network, the second network resource availability information indicating second network resources available for assignment in the containerized environment over a third time period;
after executing the machine learning algorithm, analyzing the second network resource availability information based at least in part upon a second plurality of communication conditions;
in response to analyzing the second network resource availability information, generating a second plurality of analysis results;
after executing the machine learning algorithm, generating a second plurality of network assignment recommendations based at least in part upon the second plurality of analysis results and the historical data;
assigning a third plurality of resources in the containerized environment over the third time period;
rescaling the first virtual container vertically to use the third plurality of resources; and
in conjunction with rescaling the first virtual container vertically:
reducing the plurality of processing resources by a third number, the third number being less than the first number; and
reducing the plurality of processing resources by a fourth number, the fourth number being less than the second number.

14. The method of claim 10, wherein:
the one or more virtual containers comprise a first virtual container comprising a first number of network resources; and
in conjunction with rescaling the one or more virtual containers horizontally, further comprising:
creating a second virtual container comprising a second number of network resources, the second number of network resources being equal to the first number of network resources; and
creating a third virtual container comprising a third number of network resources, the third number of network resources being equal to the second number of network resources.

15. The method of claim 14, further comprising:
determining second network resource availability information in the communication network, the second network resource availability information indicating second network resources available for assignment in the containerized environment over a third time period;
execute the machine learning algorithm to:
analyzing the second network resource availability information based at least in part upon a second plurality of communication conditions;
in response to analyzing the second network resource availability information, generating a second plurality of analysis results; and
generating a second plurality of network assignment recommendations based at least in part upon the second plurality of analysis results and the historical data;
assigning a third plurality of resources in the containerized environment over the third time period;
rescaling the first virtual container, the second virtual container, and the third virtual container horizontally to use the third plurality of resources; and
in conjunction with rescaling the first virtual container, the second virtual container, and the third virtual container horizontally, discarding the second virtual container and the third virtual container.

16. A non-transitory computer-readable medium storing instructions that when executed by a processor cause the processor to:
obtain a machine learning algorithm configured, when executed, to analyze and structure information about resources assigned in a containerized environment;
obtain historical data representative of one or more network resources assigned in the containerized environment over a first time period;
determine first network resource availability information in a communication network, the first network resource availability information indicating first network resources available for assignment in the containerized environment over a second time period;
execute the machine learning algorithm to:
analyze the first network resource availability information based at least in part upon a first plurality of communication conditions;
in response to analyzing the first network resource availability information, generate a first plurality of analysis results; and
generate a first plurality of network assignment recommendations based at least in part upon the first plurality of analysis results and the historical data;
assign a second plurality of resources in the containerized environment over the second time period; and
rescale one or more virtual containers in the containerized environment to use the second plurality of resources.

17. The non-transitory computer-readable medium of claim 16, wherein:
the one or more virtual containers are rescaled vertically and horizontally in the containerized environment.

18. The non-transitory computer-readable medium of claim 17, wherein:
a first virtual container of the one or more virtual containers comprises a plurality of processing resources and a plurality of memory resources; and
in conjunction with rescaling the one or more virtual containers vertically, the instructions further cause the processor to:
increase the plurality of processing resources by a first number; and
increase the plurality of processing resources by a second number.

19. The non-transitory computer-readable medium of claim 18, wherein the instructions further cause the processor to:
determine second network resource availability information in the communication network, the second network resource availability information indicating network resources available for assignment in the containerized environment over a third time period;
execute the machine learning algorithm to:
analyze the second network resource availability information based at least in part upon a second plurality of communication conditions;
in response to analyzing the second network resource availability information, generate a second plurality of analysis results; and
generate a second plurality of network assignment recommendations based at least in part upon the second plurality of analysis results and the historical data;
assign a third plurality of resources in the containerized environment over the third time period;
rescale the first virtual container vertically to use the third plurality of resources; and
in conjunction with rescaling the first virtual container vertically:
reduce the plurality of processing resources by a third number, the third number being equal to the first number; and
reduce the plurality of processing resources by a fourth number, the fourth number being equal to the second number.

20. The non-transitory computer-readable medium of claim 18, wherein the instructions further cause the processor to:
determine second network resource availability information in the communication network, the second network resource availability information indicating second network resources available for assignment in the containerized environment over a third time period;
execute the machine learning algorithm to:
analyze the second network resource availability information based at least in part upon a second plurality of communication conditions;
in response to analyzing the second network resource availability information, generate a second plurality of analysis results; and
generate a second plurality of network assignment recommendations based at least in part upon the second plurality of analysis results and the historical data;
assign a third plurality of resources in the containerized environment over the third time period;
rescale the first virtual container vertically to use the third plurality of resources; and
in conjunction with rescaling the first virtual container vertically:
reduce the plurality of processing resources by a third number, the third number being less than the first number; and
reduce the plurality of processing resources by a fourth number, the fourth number being less than the second number.
